(19) United States
(12) Patent Application Publication
(10) Pub. No.: US 2012/0021280 A1
(43) Pub. Date: Jan. 26, 2012

(54) COMPOSITE ELECTRODE AND ELECTRONIC DEVICE INCLUDING THE SAME

(75) Inventors: Natsuko Katase, Kanagawa (JP); Daisuke Ito, Kanagawa (JP); Shinichi Uesaka, Kanagawa (JP)

(73) Assignee: SONY CORPORATION, Tokyo (JP)

(21) Appl. No.: 13/009,274

(22) Filed: Jan. 19, 2011

(30) Foreign Application Priority Data
Jan. 25, 2010 (JP) P2010-012768

(51) Int. Cl. H01M 4/70; H01G 9/155; H01B 5/00

(52) U.S. Cl. 429/211; 174/126.1; 361/502

(57) ABSTRACT

A composite electrode includes a plate-shaped conductor; a plurality of auxiliary electrodes disposed such that ends of the plurality of auxiliary electrodes are connected to a surface of the plate-shaped conductor and the plurality of auxiliary electrodes extend from the surface of the plate-shaped conductor; and an active material layer formed between the plurality of auxiliary electrodes so as to be in contact with the plate-shaped conductor. When the height of the plurality of auxiliary electrodes is defined as h, the center-to-center spacing of auxiliary electrodes facing each other in the plurality of auxiliary electrodes or the spacing of auxiliary electrodes facing each other in the plurality of auxiliary electrodes is h or more and 2h or less.

### CROSS REFERENCES TO RELATED APPLICATIONS

The present application claims priority to Japanese Priority Patent Application JP 2010-012768 filed in the Japan Patent Office on Jan. 25, 2010, the entire contents of which are hereby incorporated by reference.

### BACKGROUND

The present application relates to a composite electrode in which loss due to internal resistance can be suppressed and an electronic device including such a composite electrode.

A decrease in the size and weight and an increase in the capacity of lithium-ion batteries and electric double layer capacitors used for various electronic devices, electric vehicles, and the like have been studied. Such a lithium-ion battery and an electric double layer capacitor include an active material.

Examples of negative electrode active materials for lithium-ion batteries include carbon materials such as graphite; and Si, Sn, and Ge that can form alloys with lithium and oxides of these metals. Examples of positive electrode active materials for lithium-ion batteries include lithium metal oxides such as LiCoO₂, LiNiO₂, and LiMn₂O₄. For the polarizable electrodes of electric double layer capacitors, activated carbon, which has a high specific surface area, is used.

However, Si, Sn, and Ge and oxides of these metals that can be used as negative electrode active materials and lithium metal oxides that can be used as positive electrode active materials have poor electron conductivity. Activated carbon, which is used for polarizable electrodes of electric double layer capacitors, also has poor electron conductivity.

Thus, studies have been performed for increasing the electron conductivity of negative electrode active materials, positive electrode active materials, activated carbon, and the like by mixing these materials with conductive agents having higher electron conductivity than the materials. Examples of such conductive agents include carbon black and carbon nanotubes. There is a technique of forming carbon nanotubes on conductors.

FIG. 12A is a sectional view illustrating the schematic structure of an existing electric double layer capacitor.

As illustrated in FIG. 12A, the electric double layer capacitor is constituted by a polarizable electrode (positive electrode) 10a; a polarizable electrode (negative electrode) 10b; a separator 13 disposed between the polarizable electrode (positive electrode) 10a and the polarizable electrode (negative electrode) 10b; a positive electrode collector 12a bonded to the polarizable electrode (positive electrode) 10a; a negative electrode collector 12b bonded to the polarizable electrode (negative electrode) 10b; an electrolytic solution 17; and a gasket 14 that is insoluble in and resistant to the electrolytic solution 17 and composed of an electrical insulating resin for filling gaps between the separator 13 and the polarizable electrodes 10a and 10b, preventing the electrolytic solution 17 from leaking, and sealing the capacitor.

There have been several reports on electrodes and composite collectors including carbon nanotubes.

For example, Japanese Unexamined Patent Application Publication No. 2004-87213 (Patent Document 1; paragraphs 0011 to 0017 and FIG. 1) titled “Electrode, method for producing electrode, capacitor, and light-emitting device” describes an electrode produced by growing carbon nanotubes or carbon fibers 103 by vapor deposition on a conductor 101 and disposing an active material substance 104 including an active material (e.g., carbon or activated carbon), a binder, an additive, and the like between the carbon nanotubes or carbon fibers.

Japanese Unexamined Patent Application Publication No. 2006-179431 (Patent Document 2; paragraphs 0014, 0036, 0081, 0082, and 0140 to 0144) titled “Composite collector including collector and carbon nano-fibers bonded to surface of collector and method for producing the same” states that a composite collector including a collector and carbon nano-fibers bonded to a surface of the collector carries an active material layer containing active material particles and the active material layer can be made to contain, in addition to activated carbon, a resin binder, a conductive agent, and the like as long as the advantages of the application are not considerably suppressed.

Japanese Unexamined Patent Application Publication No. 2007-35811 (Patent Document 3; paragraphs 0008 to 0010) titled “Electrode including carbon nanotubes and method for producing the same” states that, in an electrode constituted by a collector and carbon nanotubes disposed so as to be substantially perpendicular to a surface of the collector, the gaps between the carbon nanotubes are filled with a carbide, the carbide is prepared by carbonizing a polymer prepared by polymerizing monomers that are made present in the gaps, and representative examples of the monomers are phenol, methyl methacrylate, and the like.

### SUMMARY

Active materials relate to storage and release of energy. The positive electrode active materials and the negative electrode active materials of lithium-ion batteries relate to electrode reactions of charging reactions and discharging reactions. The electrode active materials of electric double layer capacitors relate to capacitance provided.

In electric double layer capacitors, activated carbon, which has a high specific surface area, is mainly used as an electrode active material. The larger the surface areas of polarizable electrodes of an electric double layer capacitor are, the higher the capacitance is. To increase the capacitance of an electric double layer capacitor per unit volume and unit weight, the thickness of polarizable electrodes is increased to thereby increase the surface areas of the polarizable electrodes. However, when the thickness of polarizable electrodes composed of activated carbon only is increased, since activated carbon generally has a low electric conductivity, the resistance of the polarizable electrodes is increased. Thus, there is a limit to how much the capacitance of capacitors can be increased.

For this reason, to decrease the resistance of polarizable electrodes, studies have been performed in which, by making polarizable electrodes contain a conductive auxiliary agent, the electric conductivity of the polarizable electrodes is increased to thereby increase the capacitance of capacitors. For example, a method of forming a polarizable electrode by binding activated carbon and a conductive auxiliary agent together through a binder (binder resin) has been proposed. As the binder, a fluorocarbon resin such as polytetrafluoroethylene (PTFE) is used. As the conductive auxiliary agent, carbon black such as acetylene black or furnace black, carbon fiber, carbon nanotubes, or the like is used.

The capacitance of electric double layer capacitors can be increased by using polarizable electrodes formed by a method of binding activated carbon and a conductive auxiliary agent together through a binder (binder resin). The capacity of lithium-ion batteries can be increased by using electrodes (positive electrodes and negative electrodes) formed by a method of binding active materials (negative electrode active materials and positive electrode active materials) and a conductive auxiliary agent together through a binder (binder resin). However, a further increase in the capacitance and capacity has been demanded.

In polarizable electrodes (for electric double layer capacitors) produced by the method and electrodes (for lithium-ion batteries) produced by the method, expansion and contraction caused by repeated charging and discharging weaken the bonding (binding) between particles constituting the polarizable electrodes and the electrodes and increase the resistance of the polarizable electrodes and the electrodes, which can cause degradation of cycling characteristics.

FIG. 12B illustrates current flows in the polarizable electrodes of an existing electric double layer capacitor that is being charged in which a positive electric potential is applied to the polarizable electrode (negative electrode) 10b and a negative electric potential is applied to the polarizable electrode (positive electrode) 10a.

In FIG. 12B, consider the case where the electron conductivity of the collectors (the positive electrode collector 12a and the negative electrode collector 12b) is significantly higher than that of the electrodes (the polarizable electrode (positive electrode) 10a and the polarizable electrode (negative electrode) 10b). Then, look at points A and B in the electrodes (the polarizable electrode (positive electrode) 10a and the polarizable electrode (negative electrode) 10b). Currents flow from these points in the directions perpendicular to the collectors (positive electrode collector 12a and negative electrode collector 12b) and internal resistance loss is caused that is proportional to the perpendicular distances (the length of current paths) from the points to the collectors (positive electrode collector 12a and negative electrode collector 12b) in the directions perpendicular to the collectors. That is, when the electrodes (polarizable electrode (positive electrode) 10a and polarizable electrode (negative electrode) 10b) have a large thickness, the longer the perpendicular distances of points in the electrodes from the collectors (positive electrode collector 12a and negative electrode collector 12b) are, the longer the current paths become and the larger the internal resistance becomes, which adversely affect properties of the electric double layer capacitor.

To address such a problem, for example, a technique may be employed in which the electrodes (polarizable electrode (positive electrode) 10a and polarizable electrode (negative electrode) 10b) are formed by being pressed under a high pressure so as to have a small thickness to thereby reduce the internal resistance, which is proportional to the length of current paths. However, when this technique is employed, pores through which ions migrate are made small, which reduces the ion conductivity of the electrodes.

Patent Documents 1 to 3 state that carbon nanotubes are formed so as to be perpendicular to a surface of a collector and the gaps between the carbon nanotubes are filled with an active material. However, Patent Documents 1 to 3 do not mention the spacing between or arrangement of the carbon nanotubes and hence do not disclose desired conditions about the spacing between and arrangement of the carbon nanotubes.

The present inventors have performed thorough studies on a structure formed by making an auxiliary electrode having excellent electric conductivity adhere to a collector electrode. As a result, the present inventors have found novel conditions for reducing the loss due to internal resistance.

In the following descriptions, the center-to-center distance (or center-to-center spacing) D of auxiliary electrodes (when the auxiliary electrodes are column-shaped conductors) denotes the distance between the central axes of the column-shaped conductors facing each other; and the center-to-center distance (or center-to-center spacing) D of auxiliary electrodes (when the auxiliary electrodes are wall-shaped conductors) denotes the distance between planes (hereafter, referred to as “wall thickness central planes”) running through central points of the wall thickness (plate thickness) of the wall-shaped conductors facing each other.

The spacing d of auxiliary electrodes (when the auxiliary electrodes are column-shaped conductors) denotes the distance between the column-shaped conductors facing each other; and the spacing d of auxiliary electrodes (when the auxiliary electrodes are wall-shaped conductors) denotes the distance between the wall-shaped conductors facing each other.

When the column-shaped conductors are constituted by carbon nanotubes, each conductor may be constituted by a single carbon nanotube or by a structure in which a plurality of carbon nanotubes are combined together.

It is desirable to provide a composite electrode in which loss due to internal resistance can be suppressed and an electronic device including such a composite electrode.

An embodiment relates to a composite electrode including a plate-shaped conductor (for example, plate-shaped conductor 12 or 110, positive electrode collector 12a, negative electrode collector 12b, positive electrode collector layer 30, or negative electrode collector layer 70, which are described in “Embodiments” below); a plurality of auxiliary electrodes (for example, column-shaped/wall-shaped conductors 15, column-shaped conductors 120, wall-shaped conductors 130, honeycomb conductor 135, carbon nanotubes 15a, 15b, 90a, or 90b, wall-shaped conductor parts 130a, or honeycomb conductor parts 135a, which are described in “Embodiments” below) disposed such that ends of the plurality of auxiliary electrodes are connected to a surface of the plate-shaped conductor and the plurality of auxiliary electrodes extend from the surface of the plate-shaped conductor; and an active material layer (for example, active material layer 16, porous carbon 16a or 16b, positive electrode active material layer 40, or negative electrode active material layer 64, which are described in “Embodiments” below) formed between the plurality of auxiliary electrodes so as to be in contact with the plate-shaped conductor, wherein, when a height of the plurality of auxiliary electrodes is defined as h, a center-to-center spacing of auxiliary electrodes facing each other in the plurality of auxiliary electrodes or a spacing of auxiliary electrodes facing each other in the plurality of auxiliary electrodes is h or more and 2h or less.

Another embodiment relates to an electronic device including such a composite electrode.

A composite electrode according to an embodiment includes a plate-shaped conductor; a plurality of auxiliary electrodes disposed such that ends of the plurality of auxiliary electrodes are connected to a surface of the plate-shaped conductor and the plurality of auxiliary electrodes extend from the surface of the plate-shaped conductor; and an active material layer formed between the plurality of auxiliary electrodes so as to be in contact with the plate-shaped conductor, wherein, when a height of the plurality of auxiliary electrodes is defined as h, a center-to-center spacing of auxiliary electrodes facing each other in the plurality of auxiliary electrodes or a spacing of auxiliary electrodes facing each other in the plurality of auxiliary electrodes is h or more and 2h or less. Thus, currents from points in the active material layer flow through short current paths having a distance of less than h and hence a composite electrode can be provided in which currents can be collected to the plate-shaped conductor while loss due to the internal resistance is reduced. In addition, compared with an electrode in which no auxiliary electrodes are formed, an active material layer having a thickness H is formed on a surface of a plate-shaped conductor, and the internal resistance of current paths from points in the active material layer is equal to or less than R_{H} corresponding to the distance H; in a composite electrode in which the center-to-center spacing or the spacing of auxiliary electrodes is 2H and the height of the auxiliary electrodes is αH (where α≧1), although the thickness of the active material layer is large, that is, the volume of the active material layer is large, the internal resistance of current paths from points in the active material layer to the plate-shaped conductor is equal to or less than R_{H}. Thus, a high-performance composite electrode can be provided in which currents from points in the active material layer can be collected to the plate-shaped conductor without increasing the internal resistance.

In addition, since an electronic device according to an embodiment includes such a composite electrode, a high-performance electronic device can be provided.

Additional features and advantages are described herein, and will be apparent from the following Detailed Description and the figures.

### BRIEF DESCRIPTION OF THE FIGURES

FIGS. 1A to 1C are sectional views illustrating the structure of composite electrodes including column-shaped/wall-shaped conductors according to an embodiment, FIG. 1D is a sectional view illustrating the structure of an electrode;

FIGS. 2A to 2D illustrate the structure of a composite electrode including column-shaped/wall-shaped conductors according to an embodiment and a method for producing such a composite electrode;

FIGS. 3A to 3D are sectional views illustrating the directions in which currents flow in composite electrodes according to an embodiment;

FIGS. 4A to 4C illustrate an arrangement of column-shaped conductors in a composite electrode according to an embodiment;

FIGS. 5A to 5C illustrate another arrangement of column-shaped conductors in a composite electrode according to an embodiment;

FIGS. 6A and 6B illustrate an arrangement of wall-shaped conductors in a composite electrode according to an embodiment;

FIGS. 7A and 7B illustrate other arrangements of wall-shaped conductors in a composite electrode according to an embodiment;

FIGS. 8A and 8B are sectional views illustrating the schematic structures of an electric double layer capacitor according to an embodiment;

FIGS. 9A and 9B are sectional views illustrating the schematic structures of a lithium-ion battery according to an embodiment;

FIGS. 10A1 to 10D2 are plan views illustrating other arrangements of column-shaped/wall-shaped conductors in composite electrodes according to an embodiment;

FIG. 11 is a sectional view illustrating another structure of a composite electrode including column-shaped/wall-shaped conductors according to an embodiment; and

FIGS. 12A and 12B are sectional views illustrating the schematic structure of an existing electric double layer capacitor.

### DETAILED DESCRIPTION

Embodiments of the present application will be described below in detail with reference to the drawings.

In a composite electrode according to an embodiment, the plurality of auxiliary electrodes preferably include column-shaped conductors. In such a case, a composite electrode can be provided in which the volume percentage of the active material layer formed between the auxiliary electrodes and on the plate-shaped conductor is high.

The column-shaped conductors are preferably arranged such that points at which the plate-shaped conductor and the column-shaped conductors are connected to each other constitute a square-grid pattern. In such a case, a composite electrode can be provided in which currents from points in the active material layer of the composite electrode flow through short current paths having a distance of less than h in the active material layer and loss due to the internal resistance can be suppressed.

The center-to-center spacing of column-shaped conductors facing each other in the column-shaped conductors is preferably (√2)h or more. In such a case, currents from points in the active material layer of the composite electrode flow through short current paths having a distance of less than h in the active material layer and loss due to the internal resistance can be suppressed. For example, when the center-to-center spacing of the column-shaped conductors is made (√2)h, a composite electrode can be provided in which currents from points in the active material layer of the composite electrode flow through short current paths having a distance of equal to or less than h/(√2) in the active material layer and loss due to the internal resistance can be suppressed.

The column-shaped conductors are preferably arranged such that points at which the plate-shaped conductor and the column-shaped conductors are connected to each other constitute a hexagonal-grid pattern. In such a case, a composite electrode can be provided in which currents from points in the active material layer of the composite electrode flow through short current paths having a distance of less than h in the active material layer and loss due to the internal resistance can be suppressed.

The center-to-center spacing of column-shaped conductors facing each other in the column-shaped conductors is preferably (√3)h or more. In such a case, currents from points in the active material layer of the composite electrode flow through short current paths having a distance of less than h in the active material layer and loss due to the internal resistance can be suppressed. For example, when the center-to-center spacing of the column-shaped conductors is made (√3)h, a composite electrode can be provided in which currents from points in the active material layer of the composite electrode flow through short current paths having a distance of equal to or less than (√3)h/2 in the active material layer and loss due to the internal resistance can be suppressed.

The column-shaped conductors preferably include conductive carbon nanotubes. In such a case, since the diameter of the column-shaped conductors can be made a size that is negligible relative to the center-to-center spacing of the auxiliary electrodes, a composite electrode can be provided with certainty in which the volume percentage of the active material layer formed between the auxiliary electrodes and on the plate-shaped conductor is high.

The column-shaped conductors preferably include metal nanowires or metal nanotubes. In such a case, since the diameter of the column-shaped conductors can be made a size that is negligible relative to the center-to-center spacing of the auxiliary electrodes, a composite electrode can be provided with certainty in which the volume percentage of the active material layer formed between the auxiliary electrodes and on the plate-shaped conductor is high.

The plurality of auxiliary electrodes preferably include wall-shaped conductors arranged in pairs so as to be parallel to each other.

The wall-shaped conductors preferably constitute a honeycomb structure including regions formed between the wall-shaped conductors arranged in pairs so as to be parallel to each other, and the active material layer is preferably formed in the regions.

The regions preferably have a square shape.

The regions preferably have a regular hexagonal shape.

The wall-shaped conductors preferably include conductive carbon nanowalls.

The wall-shaped conductors are preferably composed of a metal.

In such cases where the plurality of auxiliary electrodes include wall-shaped conductors arranged in pairs so as to be parallel to each other, as a result of such a simple arrangement of the auxiliary electrodes, currents from points in the active material layer flow through short current paths in the active material layer and hence a composite electrode can be provided in which currents can be collected to the plate-shaped conductor while loss due to the internal resistance is reduced.

An electronic device according to an embodiment is preferably constituted such that two of the composite electrodes are disposed so as to face each other with a separator therebetween, at least one of the composite electrodes is formed as a polarizable electrode, and the electronic device serves as an electric double layer capacitor. In such a case, currents from points in the active material layer of the polarizable electrode flow through short current paths having a distance of less than h in the active material layer and loss due to the internal resistance can be suppressed. Accordingly, an electric double layer capacitor can be provided in which a decrease in the charging-discharging capacity can be suppressed and charging-discharging characteristics are excellent.

An electronic device according to an embodiment is preferably constituted such that the electronic device includes a positive electrode including a positive electrode collector and a positive electrode active material layer; a negative electrode including a negative electrode collector and a negative electrode active material layer; and an electrolytic layer disposed between the positive electrode and the negative electrode, wherein at least one of the positive electrode and the negative electrode includes the composite electrode, and the electronic device serves as a secondary battery. In such a case, currents from points in the positive electrode active material layer and the negative electrode active material layer flow through short current paths having a distance of less than h in the positive electrode active material layer and the negative electrode active material layer and loss due to the internal resistance can be suppressed. Accordingly, a secondary battery can be provided in which a decrease in the charging-discharging capacity can be suppressed and charging-discharging characteristics are excellent.

The secondary battery is preferably a lithium-ion secondary battery. In such a case, a high-performance lithium-ion battery can be provided.

A composite electrode according to an embodiment includes a plate-shaped conductor; a plurality of auxiliary electrodes that are conductive and are disposed such that ends of the plurality of auxiliary electrodes are connected to a surface of the plate-shaped conductor and the plurality of auxiliary electrodes extend from the surface of the plate-shaped conductor; and an active material layer formed between the plurality of auxiliary electrodes so as to be in contact with the plate-shaped conductor, wherein, when a height of the plurality of auxiliary electrodes is defined as h, a center-to-center spacing of auxiliary electrodes facing each other in the plurality of auxiliary electrodes is h or more and 2h or less. The auxiliary electrodes may be formed so as to be perpendicular to the surface of the plate-shaped conductor or inclined with respect to the surface of the plate-shaped conductor.

The plurality of auxiliary electrodes may include column-shaped conductors and/or wall-shaped conductors. The column-shaped conductors may include carbon nanotubes, metal columns, or the like. The column-shaped conductors may be arranged in a square-grid pattern such that the center-to-center spacing of column-shaped conductors facing each other is (√2)h or more. Alternatively, the column-shaped conductors may be arranged in a hexagonal-grid pattern such that the center-to-center spacing of column-shaped conductors facing each other is (√3)h or more.

The wall-shaped conductors may include carbon nanowalls or may be composed of a metal. The wall-shaped conductors may be arranged in pairs so as to be parallel to each other and may constitute a honeycomb structure including recesses having a square shape or a hexagonal shape.

Since currents from points in the active material layer flow through shortest current paths to the plate-shaped conductor or via auxiliary electrodes to the plate-shaped conductor, loss due to the internal resistance can be suppressed. For example, when the center-to-center spacing of auxiliary electrodes facing each other is 2h, (√3)h, (√2)h, or h, currents from points in the active material layer flow through shortest current paths respectively having a distance of equal to or less than h, (√3)h/2, h/(√2), or h/2 to the plate-shaped conductor or via auxiliary electrodes to the plate-shaped conductor. Accordingly, loss due to the internal resistance is small.

Compared with an electrode in which no auxiliary electrodes are formed, an active material layer having a thickness H is formed on a surface of a plate-shaped conductor, and the internal resistance of current paths from points in the active material layer is equal to or less than R_{H} corresponding to the distance H; in a composite electrode in which the center-to-center spacing or the spacing of auxiliary electrodes is 2H and the height of the auxiliary electrodes is αH (where α≧1), which is α times the thickness H of the active material layer of the electrode including no auxiliary electrodes, even when the thickness of the active material layer is increased, that is, the volume of the active material layer is increased, the internal resistance of current paths from points in the active material layer to the plate-shaped conductor is equal to or less than R_{H}. Thus, a high-performance composite electrode can be provided in which currents from points in the active material layer can be collected without increasing the internal resistance.

Such a composite electrode is suitably applied to an electric double layer capacitor. In such a case, two composite electrodes are disposed so as to face each other with a separator therebetween and at least one of the composite electrodes is formed as a polarizable electrode.

Such a composite electrode is suitably applied to a lithium-ion battery. In such a case, the lithium-ion battery includes a positive electrode including a positive electrode collector and a positive electrode active material layer and a negative electrode including a negative electrode collector and a negative electrode active material layer, and at least one of the positive electrode and the negative electrode includes the composite electrode.

In such an electric double layer capacitor, loss due to the internal resistance of current paths in the active material layer of the polarizable electrode can be suppressed. In such a lithium-ion battery, loss due to the internal resistance of current paths in the active material layers (positive electrode active material layer and negative electrode active material layer) can be suppressed. As a result, an electric double layer capacitor and a lithium-ion battery can be achieved in which a decrease in the charging-discharging capacity can be suppressed and charging-discharging characteristics are excellent.

Hereinafter, embodiments according to the present application will be described in detail with reference to drawings.

### Embodiments

Composite Electrodes Including Column-Shaped Conductors or Wall-Shaped Conductors

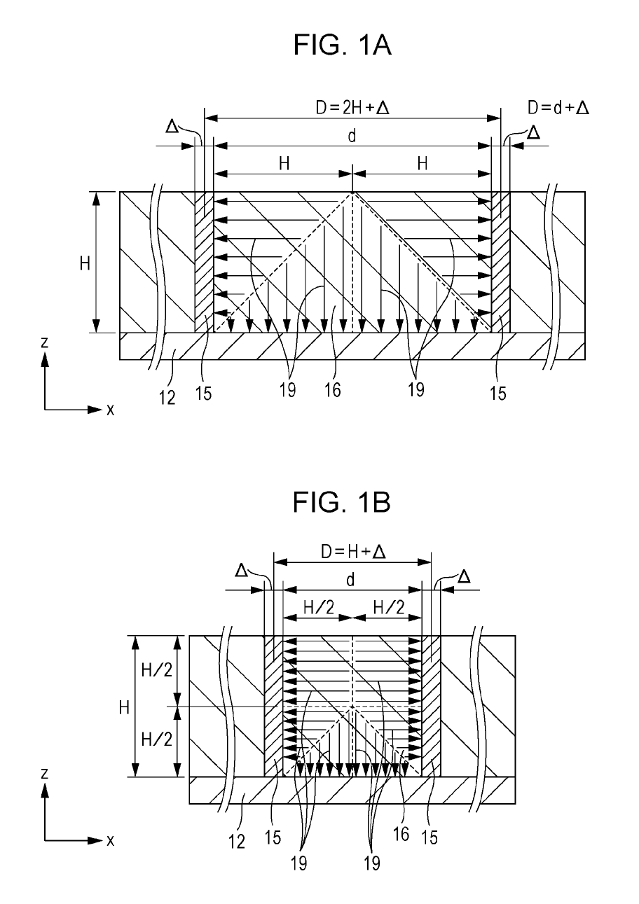

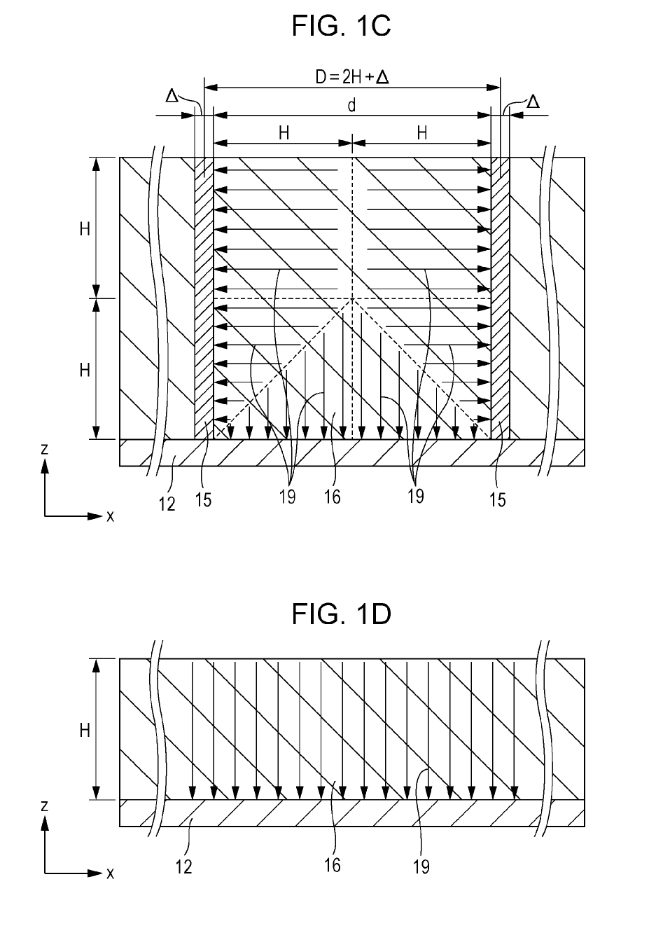

FIGS. 1A to 1C are sectional views illustrating the structures of composite electrodes including, as auxiliary electrodes, column-shaped conductors or wall-shaped conductors according to an embodiment. FIG. 1D is a sectional view illustrating the structure of an electrode. Specifically, FIG. 1A illustrates current paths in the active material layer when the spacing between the auxiliary electrodes is twice the height of the auxiliary electrodes; FIGS. 1B and 1C illustrate current paths in the active material layers when the spacing between the auxiliary electrodes is equal to the height of the auxiliary electrodes; and FIG. 1D illustrates current paths in the active material layer when no auxiliary electrodes are formed.

FIGS. 1A to 1C illustrate examples where conductive auxiliary electrodes (column-shaped/wall-shaped conductors 15) are formed on a surface of a plate-shaped conductor 12 so as to be perpendicular to the surface and active material layers 16 are disposed between the auxiliary electrodes; and FIGS. 1A to 1C illustrate directions 19 in which currents flow in the active material layers 16.

FIGS. 1A to 1C and FIGS. 2B, 2C, 3A, 3C, 3D, 4B, 4C, 5B, and 5C that are described below illustrate composite electrodes in electric double layer capacitors that are being charged in which a positive electric potential is applied to the composite electrodes.

Referring to FIGS. 1A to 1C, ends of the auxiliary electrodes having a height H or 2H are connected to the surface of the plate-shaped conductor 12 such that the auxiliary electrodes are perpendicular to the surface. The symbol A denotes the diameter of the column-shaped conductors 15 and the wall thickness (plate thickness) of the wall-shaped conductors 15. The column-shaped/wall-shaped conductors 15 are formed of a material having a lower electrical resistance than the active material layer 16.

FIGS. 1A to 1C illustrate examples where the column-shaped conductors 15 serving as the auxiliary electrodes are formed such that the central axes of the column-shaped conductors 15 are perpendicular to the surface of the plate-shaped conductor 12 or the wall-shaped conductors 15 serving as the auxiliary electrodes are formed such that the wall surfaces of the wall-shaped conductors 15 are perpendicular to the surface of the plate-shaped conductor 12. However, the column-shaped conductors 15 may be formed such that the central axes thereof are inclined with respect to the surface of the plate-shaped conductor 12. The wall-shaped conductors 15 may be formed such that the wall surfaces thereof are inclined with respect to the surface of the plate-shaped conductor 12.

The column-shaped conductors 15 may be linear or bent in the direction in which the column-shaped conductors 15 extend. The wall surfaces of the wall-shaped conductors 15 may be flat surfaces or irregularly shaped meandering surfaces in the direction in which the wall-shaped conductors 15 extend or in a direction intersecting the direction in which the wall-shaped conductors 15 extend.

FIG. 1A illustrates current paths from points in the active material layer 16 to the auxiliary electrodes and the plate-shaped conductor 12 when the auxiliary electrodes are formed so as to have a height H, a spacing d=2H, and an auxiliary-electrode center-to-center distance D=2H+Δ.

As illustrated in FIG. 1A, currents flow in the shortest paths from points in the active material layer 16 to the plate-shaped conductor 12 or the auxiliary electrodes. The directions 19 in which the currents flow are perpendicular to the plate-shaped conductor 12 or the auxiliary electrodes.

Currents from points on a line that is a perpendicular distance H away from the auxiliary electrodes in the active material layer 16 flow through current paths having the shortest distance H to the auxiliary electrodes. Currents from points on a line that is a perpendicular distance H away from the plate-shaped conductor 12 in the active material layer 16 flow through current paths having the shortest distance H to the plate-shaped conductor 12. Currents from points other than the points on the lines in the active material layer 16 between the auxiliary electrodes flow through current paths having a distance less than H to the auxiliary electrodes or the plate-shaped conductor 12. That is, when the internal resistance of a current path having a distance H is defined as R_{H}, the internal resistance of the current paths from the points on the lines is equal to R_{H} and the internal resistance of the current paths from the points other than the points on the lines is less than R_{H}.

FIG. 1B illustrates current paths from points in the active material layer 16 to the auxiliary electrodes or the plate-shaped conductor 12 when the auxiliary electrodes are formed so as to have a height H, a spacing d=H, and an auxiliary-electrode center-to-center distance D=H+Δ.

As illustrated in FIG. 1B, currents flow through the shortest paths from points in the active material layer 16 to the plate-shaped conductor 12 or the auxiliary electrodes. Thus, the currents from points in the active material layer 16 between the auxiliary electrodes flow through current paths having a distance equal to or less than (½)H to the auxiliary electrodes or the plate-shaped conductor 12. That is, the internal resistance of the current paths is less than R_{H}/2.

FIG. 1C illustrates current paths from points in the active material layer 16 to the auxiliary electrodes or the plate-shaped conductor 12 when the auxiliary electrodes are formed so as to have a height 2H, a spacing d=2H, and an auxiliary-electrode center-to-center distance D=2H+Δ.

As illustrated in FIG. 1C, currents flow through the shortest paths from points in the active material layer 16 to the plate-shaped conductor 12 or the auxiliary electrodes. Thus, currents from points on the lines that are a perpendicular distance H away from the auxiliary electrodes or a perpendicular distance H or more and 2H or less away from the plate-shaped conductor 12 in the active material layer 16 flow through current paths having the shortest distance H to the auxiliary electrodes or the plate-shaped conductor 12.

Currents from points other than the points on the lines in the active material layer 16 between the auxiliary electrodes flow through current paths having a distance less than H to the auxiliary electrodes or the plate-shaped conductor 12. That is, the internal resistance of the current paths from the points on the lines is equal to R_{H} and the internal resistance of the current paths from the points other than the points on the lines is less than R_{H}.

FIG. 1D illustrates current paths from points in the active material layer 16 having a thickness H to the plate-shaped conductor 12 when no auxiliary electrodes are formed. The shortest distance from points in the active material layer 16 to the plate-shaped conductor 12 is equal to the length of lines that perpendicularly extend from the points to the plate-shaped conductor 12. Thus, the current paths have a length equal to or less than H and the internal resistance of the current paths is equal to or less than R_{H}.

In each composite electrode illustrated in FIGS. 1A to 1C, since currents from points in the active material layer 16 flow through current paths having a distance equal to or less than H to the auxiliary electrodes or the plate-shaped conductor 12, the internal resistance of the current paths is equal to or less than R_{H}.

Although the structures of the composite electrodes illustrated in FIGS. 1B and 1C are common in that the auxiliary electrodes are formed such that the spacing of the auxiliary electrodes is equal to the height of the auxiliary electrodes, these composite electrodes have considerably different performances. In the auxiliary electrodes of the composite electrode illustrated in FIG. 1C, the thickness of the active material layer 16 is twice that of the active material layer 16 in the electrode illustrated in FIG. 1D and the internal resistance of the current paths is equal to or less than R_{H}. Thus, the composite electrode in FIG. 1C has an advantage in that it can collect currents from points in the active material layer 16 without increasing the internal resistance.

The auxiliary electrodes of the composite electrode illustrated in FIG. 1B have a height H. However, when the thickness of an active material layer in an electrode including no auxiliary electrodes but the active material layer is defined as H, even when the auxiliary electrodes of a composite electrode has a height αH (where α≧1), as long as the spacing d of the auxiliary electrodes satisfy (H/2)≦d≦H, the composite electrode obviously has an advantage similar to the above-described advantage.

The auxiliary electrodes of the composite electrode illustrated in FIG. 1C have a height 2H. However, when the thickness of an active material layer in an electrode including no auxiliary electrodes but the active material layer is defined as H, even when the auxiliary electrodes of a composite electrode has a height αH (where α≧1), as long as the spacing d of the auxiliary electrodes satisfy H≦d≦2H, the composite electrode obviously has an advantage similar to the above-described advantage.

Compared with the electrode in FIG. 1D in which no auxiliary electrodes are formed, the active material layer 16 having a thickness H is formed on the surface of the plate-shaped conductor 12, and the internal resistance of the current paths from points in the active material layer 16 is equal to or less than R_{H} corresponding to the distance H; in a composite electrode in which the auxiliary electrodes have a height αH (where α≧1) and the spacing d of the auxiliary electrodes satisfy H≦d≦2H, even when the thickness of the active material layer 16 is increased, that is, the volume of the active material layer 16 is increased, the internal resistance of current paths from points in the active material layer 16 to the plate-shaped conductor 12 is equal to or less than R_{H}. Thus, a high-performance composite electrode can be provided in which currents from points in the active material layer 16 can be collected to the plate-shaped conductor 12 without increasing the internal resistance.

As has been described so far, in a composite electrode in which auxiliary electrodes have a height αH (where α≧1) and the spacing d of the auxiliary electrodes satisfy H≦d≦2H, the internal resistance of the composite electrode can be made equal to or less than RH, which is the internal resistance of an electrode including the active material layer 16 having a thickness H and no auxiliary electrodes.

In FIGS. 1A to 1C, since a relationship D>d is satisfied, when a relationship H≦d is satisfied, a relationship H<D is satisfied; when a relationship D 2H is satisfied, a relationship d<2H is satisfied. Accordingly, a relationship H<D≦2H is satisfied. To reduce the region in which the active material layer 16 is not formed due to the presence of the auxiliary electrodes as much as possible, Δ is desirably made significantly smaller than D and d. In such a case, since A is significantly smaller than D and d and hence negligible, the condition of H≦d≦2H and the condition of H<D≦2H are nearly equivalent to each other and can be regarded as being substantially equivalent to each other.

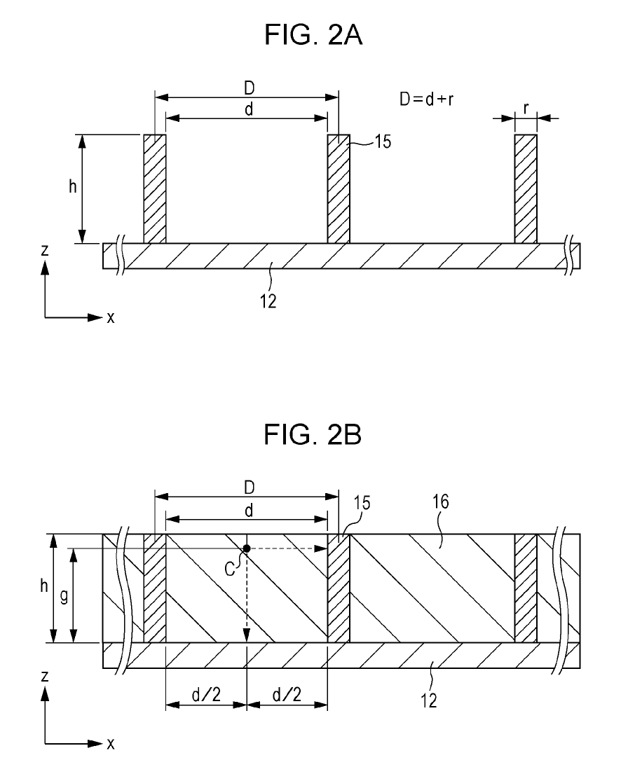

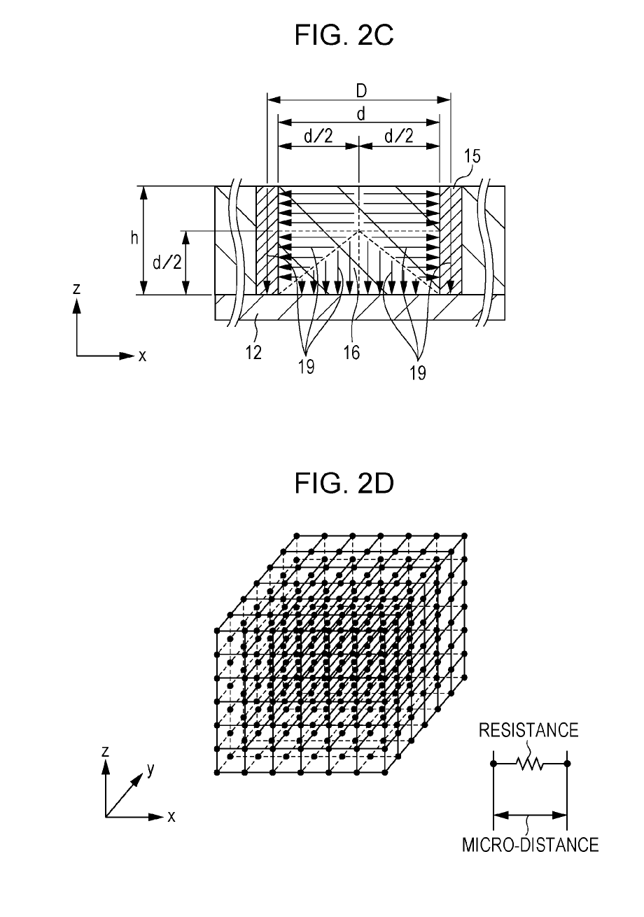

FIGS. 2A to 2D illustrate the structure of a composite electrode including, as auxiliary electrodes, column-shaped conductors or wall-shaped conductors according to an embodiment and a method for producing such a composite electrode. Specifically, FIG. 2A is a sectional view illustrating the formation of column-shaped conductors or wall-shaped conductors; FIG. 2B is a sectional view illustrating the formation of an active material layer and current flows in the active material layer; FIG. 2C is a sectional view illustrating the direction in which currents flow in the active material layer; and FIG. 2D is a perspective view illustrating a resistance network that is analogous to the active material layer.

FIGS. 2A to 2C illustrate an example where conductive auxiliary electrodes (column-shaped/wall-shaped conductors 15) are formed on a surface of the plate-shaped conductor 12 so as to be perpendicular to the surface.

Auxiliary Electrodes

FIG. 2A is an xz sectional view illustrating the state in which the column-shaped/wall-shaped conductors 15 are formed on the surface of the plate-shaped conductor 12 disposed so as to be parallel to the xy plane, such that the column-shaped/wall-shaped conductors 15 are perpendicular to the surface and extend in the z direction.

As illustrated in FIG. 2A, ends of the column-shaped/wall-shaped conductors 15 that serve as auxiliary electrodes and have a height h are connected to the surface of the plate-shaped conductor 12 such that the column-shaped/wall-shaped conductors 15 are perpendicular to the surface of the plate-shaped conductor 12. The symbol r denotes the diameter of the column-shaped conductors 15 and the wall thickness (plate thickness) of the wall-shaped conductors 15. In the x direction, the spacing of the auxiliary electrodes is defined as d and the center-to-center distance of the auxiliary electrodes is defined as D. The column-shaped/wall-shaped conductors 15 are formed of a material having a lower electrical resistance than the active material layer 16.

When the auxiliary electrodes are formed such that the height h thereof, the center-to-center distance D thereof, and the diameter r or the wall thickness (plate thickness) r thereof satisfy a relationship r<D≦2h, the active material layer 16 can be formed between the auxiliary electrodes. The larger a difference (D−r) is, the higher the volume percentage of the active material layer 16 formed between the auxiliary electrodes and on the plate-shaped conductor 12 (the volume percentage={(the volume of the active material layer 16)/(the sum of the volume of the auxiliary electrodes and the volume of the region between the auxiliary electrodes, that is, the volume of the active material layer 16)}×100(%)) is.

When devices such as electric double layer capacitors and lithium-ion batteries include composite electrodes having a high volume percentage, the devices have a high charging-discharging capacity. Accordingly, it is desirable that the diameter r or the wall thickness (plate thickness) r is as small as possible and the volume percentage is as high as possible. Specifically, the volume percentage is preferably 90% or more and, more preferably, 95% or more.

The column-shaped/wall-shaped conductors 15 are formed such that the spacing d thereof or the center-to-center distance D thereof satisfies, with respect to the height h thereof, a relationship h≦D≦2h or h≦d≦2h. For the column-shaped conductors 15, the diameter thereof is made as small as possible. For the wall-shaped conductors 15, the wall thickness thereof is made as small as possible.

In the configuration in which the column-shaped/wall-shaped conductors 15 are formed on the surface of the plate-shaped conductor 12 so as to be electrically connected to the plate-shaped conductor 12, currents from points in the active material layer 16 formed between the column-shaped/wall-shaped conductors 15 flow through short current paths having a distance h or less and hence are collected to the plate-shaped conductor 12 while loss due to the internal resistance is suppressed.

When the column-shaped/wall-shaped conductors 15 are formed such that the spacing d thereof or the center-to-center distance D thereof are made excessively small with respect to the height h thereof, currents from points in the active material layer 16 formed between the column-shaped/wall-shaped conductors 15 can be made to flow through short current paths and can be collected to the plate-shaped conductor 12 while loss due to the internal resistance is further suppressed. However, since the amount of the active material used for the composite electrode is small, the performance of a device including such a composite electrode, for example, the charging-discharging capacity of an electric double layer capacitor or a lithium-ion battery is decreased, which is not preferred.

As described above, by forming the column-shaped/wall-shaped conductors 15 such that the relationship h≦D≦2h or h≦d≦2h is satisfied, the diameter of the column-shaped conductors 15 is as small as possible, and the wall thickness of the wall-shaped conductors 15 is as small as possible, loss due to the internal resistance can be suppressed and degradation of the performance of devices including composite electrodes can be suppressed.

As illustrated in FIG. 2A, since a relationship D=(d+r) is satisfied, when a relationship D≦2h is satisfied, relationships (d+r)≦2h and r>0 are satisfied. Accordingly, a relationship d<2h, that is, (d/2)<h is satisfied.

Although, in the example illustrated in FIG. 2A, the column-shaped conductors 15 are formed such that the central axes thereof are perpendicular to the surface of the plate-shaped conductor 12, the column-shaped conductors 15 may be formed such that the central axes thereof are inclined with respect to the surface of the plate-shaped conductor 12. The column-shaped conductors 15 may be linear or bent in the direction in which the column-shaped conductors 15 extend.

Although, in the example illustrated in FIG. 2A, the wall-shaped conductors 15 are formed such that the wall surfaces thereof are perpendicular to the surface of the plate-shaped conductor 12. However, the wall-shaped conductors 15 may be formed such that the wall surfaces thereof are inclined with respect to the surface of the plate-shaped conductor 12. The wall surfaces of the wall-shaped conductors 15 may be flat surfaces or irregularly shaped meandering surfaces in the direction in which the wall-shaped conductors 15 extend or in a direction intersecting the direction in which the wall-shaped conductors 15 extend.

As column-shaped conductors used as conductive auxiliary electrodes in FIGS. 1A to 1C and 2A to 2C, there are, for example, conductive structures constituted by carbon nanotubes, carbon nanowalls, metal nanotubes, metal nanorods, metal nanowires, or the like. As wall-shaped conductors used as conductive auxiliary electrodes in FIGS. 1A to 1C and 2A to 2C, there are, for example, carbon nanowalls that are formed so as to extend in a labyrinth-like configuration on a surface of a conductive substrate and that are carbon nanostructures having a wall configuration extending two-dimensionally; or honeycomb structures composed of a metal.

Formation of Active Material Layer

As illustrated in FIG. 2B, in the recesses that are formed between the column-shaped/wall-shaped conductors 15 and the plate-shaped conductor 12 and are illustrated in FIG. 2A, the active material layer 16 is formed so as to be in contact with the surfaces of the column-shaped/wall-shaped conductors 15 and the plate-shaped conductor 12. For example, the active material layer 16 is formed in the recesses in any one of the following manners.

(1) A paste prepared by dispersing an active material in an organic solvent is applied into the recesses. The organic solvent is then vaporized from the applied paste.

(2) A paste prepared by dispersing an active material and a binder in an organic solvent is applied into the recesses. The organic solvent is then vaporized from the applied paste.

(3) A paste prepared by dispersing an active material, a binder, and a conductive auxiliary agent in an organic solvent is applied into the recesses. The organic solvent is then vaporized from the applied paste.

(4) An active material and an organic solvent are dispersed in a polymer gel. This polymer gel is then applied into the recesses.

(5) An active material is dispersed in a polymer matrix so as to be held in the polymer matrix without using an organic solvent. The polymer matrix is then applied into the recesses.

(6) An active material is sputtered so as to fill the recesses.

(7) When porous carbon is used as an active material, the porous carbon may be formed by, for example, filling the recesses with a mixed solution of a phenolic compound, an aldehyde compound, and a catalytic compound; heating the mixed solution to form a polymer; and then heating the polymer at a high temperature to thereby carbonize the polymer.

Current Flows in Active Material Layer

Hereinafter, current flows from an active material layer will be described with reference to FIGS. 2B and 2C.

As illustrated in FIG. 2B, the column-shaped/wall-shaped conductors 15 are formed as auxiliary electrodes so as to be in contact with a surface of the plate-shaped conductor 12 and be perpendicular to the surface. The auxiliary electrodes are formed of a material having a considerably low electrical resistance such as carbon nanotubes, compared with the active material layer 16.

When the density of the auxiliary electrodes formed on the surface of the plate-shaped conductor 12 is made excessively large, the amount of the active material layer 16 contributing to the capacitance becomes small, which causes a decrease in the capacitance. Accordingly, as described above, by making the diameter of the column-shaped conductors 15 be as small as possible or making the wall thickness of the wall-shaped conductors 15 be as small as possible and forming, as auxiliary electrodes, the column-shaped/wall-shaped conductors 15 so as to satisfy the relationship h≦D≦2h or h≦d≦2h, loss due to the internal resistance is suppressed and a decrease in the capacitance is suppressed.

In FIG. 2B, consider point C that is equidistant from the neighboring auxiliary electrodes and is a distance g away from the surface of the plate-shaped conductor 12. When the auxiliary electrodes have a considerably lower electrical resistance than the active material layer 16, the resistance of the auxiliary electrodes is negligible. When a current flows through the active material layers 16, which causes internal resistance, as illustrated by dotted lines, there are a first path (first current path) through which the current flows to the plate-shaped conductor 12 in a direction perpendicular to the plate-shaped conductor 12 and a second path (second current path) through which the current flows to the auxiliary electrode in a direction perpendicular to the auxiliary electrode.

In an embodiment, to make a current flow through the shorter path (current path) between the first path and the second path, as described above, a composite electrode is formed such that the diameter of the column-shaped conductors 15 is made as small as possible or the wall thickness of the wall-shaped conductors 15 is made as small as possible and the auxiliary electrodes (column-shaped/wall-shaped conductors 15) are formed so as to satisfy the relationship h≦D≦2h or h≦d≦2h.

When a composite electrode has such a structure, since current paths in the active material layer 16 can be made shorter and the internal resistance can be made smaller, the following advantages can be provided: (1) the loss can be suppressed; (2) a decrease in the capacity can be suppressed; (3) the output loss of the electric double layer capacitor can be reduced; (4) the thickness of the active material layer 16 can be made large; (5) heat generated by the internal resistance can be reduced; and the like.

FIG. 2C illustrates current-flow directions 19 in the active material layer 16 when the column-shaped/wall-shaped conductors 15 disposed so as to be perpendicular to the plate-shaped conductor 12 are formed so as to satisfy the relationship h≦D≦2h or h≦d≦2h.

FIG. 2D illustrates the approximation of the active material layer 16 into a three-dimensional resistance network in which a micro-distance between two points in the active material layer 16 is substituted with a single resistance.

Since the column-shaped/wall-shaped conductors 15 are formed so as to satisfy the relationship h≦D≦2h or h≦d≦2h, as illustrated in FIG. 2C, in two square regions having a side length of (d/2) in the active material layer 16, currents flow from the two square regions to the column-shaped/wall-shaped conductors 15 or the plate-shaped conductor 12 in the current-flow directions 19 perpendicular to the column-shaped/wall-shaped conductors 15 or the plate-shaped conductor 12; and, in a rectangular region having a long-side length of d and a short-side length of (h−(d/2)) in the active material layer 16, currents flow from the rectangular region to the column-shaped/wall-shaped conductors 15 in the current-flow directions 19 perpendicular to the column-shaped/wall-shaped conductors 15.

When the column-shaped/wall-shaped conductors 15 serving as auxiliary electrodes are not formed, currents flow from the region that is in the active material layer 16 and is a distance h or less away from the plate-shaped conductor 12 to the plate-shaped conductor 12 in the current-flow directions 19 perpendicular to the plate-shaped conductor 12. In the example illustrated in FIG. 2C, by forming the column-shaped/wall-shaped conductors 15 such that the relationship D≦2h is satisfied and hence the relationship (d/2)<h is satisfied, currents flow from the active material layer 16 in the shortest current paths to the column-shaped/wall-shaped conductors 15 or the plate-shaped conductor 12. Thus, the resistance is low and loss due to the internal resistance can be suppressed.

Accordingly, in the example illustrated in FIG. 2C, currents from points that are a perpendicular distance h away from the plate-shaped conductor 12 flow through current paths having a distance (d/2), which is shorter than the distance h, to the plate-shaped conductor 12. Thus, the resistance is not high.

In FIG. 2C, when the distance d between the auxiliary electrodes facing each other is 2h, currents from points, in the active material layer 16, that are on a line a perpendicular distance h away from these auxiliary electrodes or on a line a perpendicular distance h away from the plate-shaped conductor 12 flow through shortest current paths having the distance h to the auxiliary electrodes or the plate-shaped conductor 12.

In the active material layer 16 between the auxiliary electrodes facing each other, currents from points in the active material layer 16 other than the above-described points on the lines flow through current paths having a distance less than h to the auxiliary electrodes or the plate-shaped conductor 12. That is, when the internal resistance of a current path having a length (distance h) is defined as Rₕ, the internal resistance of the current paths from the points on the lines is equal to Rₕ and the internal resistance of the current paths from the points other than the points on the lines is less than Rₕ.

In FIG. 2C, when the distance d between the auxiliary electrodes facing each other is h, currents from all the points in the active material layer 16 between these auxiliary electrodes flow through current paths having a distance (h/2) or less to the auxiliary electrodes or the plate-shaped conductor 12. In this case, the internal resistance of the current paths is (Rₕ/2) or less.

In FIG. 2C, when the height h of the auxiliary electrodes is changed to 2h and D is made to be equal to 2h, the auxiliary electrodes having the height 2h are disposed at a center-to-center spacing equal to the height. In FIG. 2C, when the height h of the auxiliary electrodes is changed to 2h and d is made to be equal to 2h, the auxiliary electrodes having the height 2h are disposed at a spacing equal to the height.

In the case of D=2h and the case of d=2h, currents from points in the active material layer 16 having a height 2h between auxiliary electrodes flow through current paths having a distance h or less to the auxiliary electrodes or the plate-shaped conductor 12. That is, the internal resistance of the current paths is Rₕ or less.

In an electrode in which no auxiliary electrodes are formed and an active material layer having a thickness h is formed on a surface of the plate-shaped conductor 12, current paths from points in the active material layer have a distance h or less and the internal resistance is equal to or less than the resistance corresponding to the length of the current paths. When the internal resistance of a current path having a distance h is defined as Rₕ, in the case of D=2h and the case of d=2h, the internal resistance is Rₕ or less.

Accordingly, by disposing auxiliary electrodes having a height (2H) that is twice the thickness (H=h) of the active material layer of an electrode including no auxiliary electrodes and by forming the active material layer 16 between the auxiliary electrodes, that is, by making the center-to-center spacing of the auxiliary electrodes or the spacing of the auxiliary electrodes be equal to the height of the auxiliary electrodes, a composite electrode including an active material layer having a thickness that is twice the thickness of the active material layer of an electrode including no auxiliary electrodes can be provided. In such a composite electrode, even when the volume of the active material layer 16 is increased, the internal resistance of current paths from points in the active material layer 16 to the plate-shaped conductor 12 is Rₕ or less. Thus, a high-performance composite electrode can be provided in which currents from points in the active material layer 16 can be collected without increasing the internal resistance.

Compared with an electrode in which no auxiliary electrodes are formed and an active material layer having a thickness H (=h) is formed on a surface of the plate-shaped conductor 12; in a composite electrode in which the center-to-center spacing of auxiliary electrodes or the spacing of the auxiliary electrodes is 2H and the auxiliary electrodes have a height αH (where α≧2), even when the volume of the active material layer 16 is increased, the internal resistance of current paths from points in the active material layer 16 to the plate-shaped conductor 12 is Rₕ or less. Thus, a high-performance composite electrode can be provided in which currents from points in the active material layer 16 can be collected without increasing the internal resistance.

Hereinafter, cases where the column-shaped/wall-shaped conductors 15 serving as auxiliary electrodes are formed so as to be not perpendicular to a surface of the plate-shaped conductor 12 but be inclined with respect to the surface of the plate-shaped conductor 12 will be described.

Current Directions in Composite Electrode

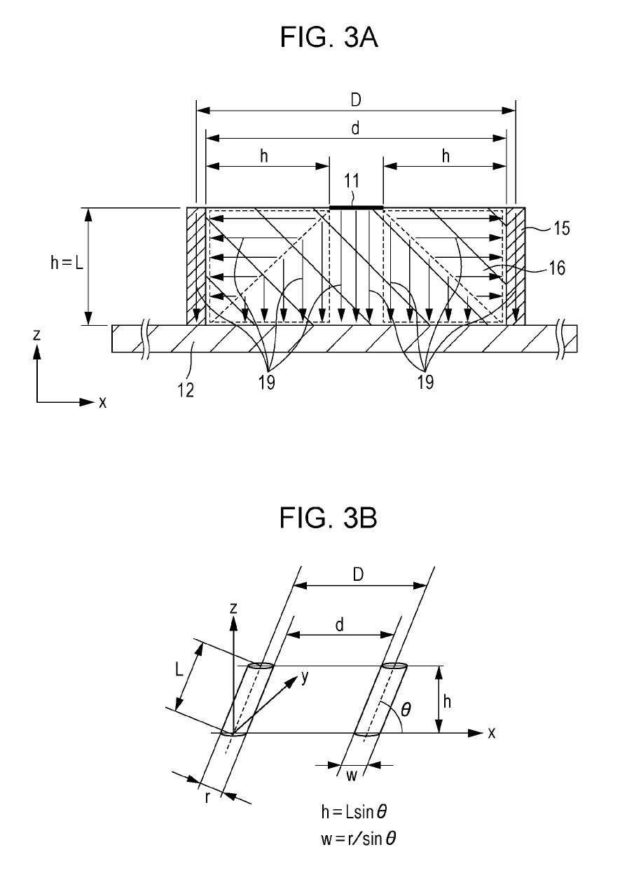

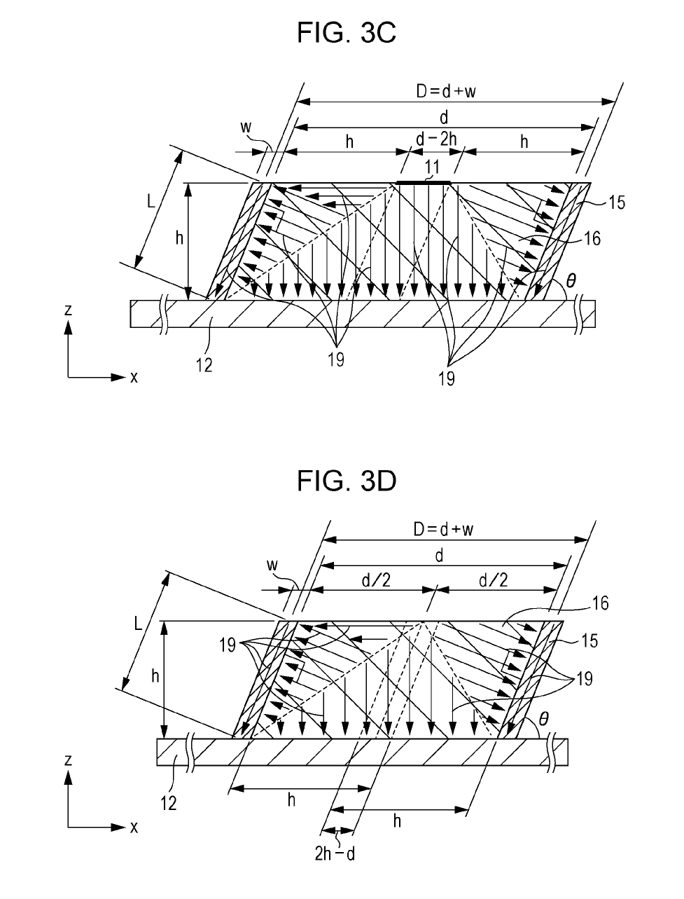

FIGS. 3A to 3D are sectional views illustrating directions in which currents flow in composite electrodes according to an embodiment.

FIG. 3A illustrates the directions 19 in which currents flow in the active material layer 16 when, in the structure illustrated in FIG. 2C in which auxiliary electrodes (column-shaped/wall-shaped conductors 15) are formed on a surface of the plate-shaped conductor 12 so as to be perpendicular to the surface, the column-shaped/wall-shaped conductors 15 are formed such that the center-to-center distance D thereof does not satisfy the relationship h≦D≦2h or h≦d≦2h.

In FIG. 3A, currents from two square regions having a side length of h (=L) in the active material layer 16 flow in the directions 19 perpendicular to the column-shaped/wall-shaped conductors 15 or the plate-shaped conductor 12 toward the column-shaped/wall-shaped conductors 15 or the plate-shaped conductor 12, through current paths shorter than the distance h to the column-shaped/wall-shaped conductors 15 or the plate-shaped conductor 12.

Currents from a rectangular region having a long-side length of h (=L) and a short-side length of (d−2h) in the active material layer 16 flow in the directions 19 perpendicular to the plate-shaped conductor 12 toward the plate-shaped conductor 12. Points (including end points) on a side (represented by a bold line) of the rectangular region, the side being opposite the plate-shaped conductor 12, are a perpendicular distance h (=L) away from the plate-shaped conductor 12. Currents from the rectangular region having a long-side length of h (=L) and a short-side length of (d−2h) in the active material layer 16 flow through current paths having a distance h to the plate-shaped conductor 12.

Since currents from these points flow through the current paths having a distance h and the resistance is high, loss due to the internal resistance is not suppressed. Thus, the points (including end points) on the side opposite the plate-shaped conductor 12 are in a high-resistance region 11 (in which loss due to the internal resistance is high) (points on the bold line).

In the example illustrated in FIG. 3A, currents from all the points in the active material layer 16 between the column-shaped/wall-shaped conductors 15 facing each other except the above-described points flow through current paths having a distance h or less to the column-shaped/wall-shaped conductors 15 or the plate-shaped conductor 12.

In the example illustrated in FIG. 3B, cylindrical conductors that are inclined by an angle θ with respect to a surface (xy surface) of the plate-shaped conductor 12 are formed on the surface of the plate-shaped conductor 12 in which the cylindrical conductors having a length L are disposed at a spacing d or the cylindrical conductors having a height h are disposed at the center-to-center distance D of the column-shaped/wall-shaped conductors 15.

FIG. 3C illustrates the directions 19 in which currents flow in the active material layer 16 when, in the structure illustrated in FIG. 3B in which the column-shaped/wall-shaped conductors 15 are formed on a surface of the plate-shaped conductor 12 so as to be not perpendicular to the surface but be inclined at an angle θ with respect to the surface, and the column-shaped/wall-shaped conductors 15 are formed such that the relationship h≦D≦2h or h≦d≦2h is not satisfied. In the example illustrated in FIG. 3C, when d is made to be equal to 2h, the parallelogram region having side lengths of L and (d−2h) is not present.

In FIG. 3C, currents from the right parallelogram region having side lengths of L and h in the active material layer 16 flow in the directions 19 perpendicular to the column-shaped/wall-shaped conductors 15 or the plate-shaped conductor 12 toward the column-shaped/wall-shaped conductors 15 or the plate-shaped conductor 12, through current paths shorter than the distance h to the column-shaped/wall-shaped conductors 15 or the plate-shaped conductor 12.

Currents from the left parallelogram region having side lengths of L and h in the active material layer 16 flow in the directions 19 that are perpendicular to the column-shaped/wall-shaped conductors 15 or the plate-shaped conductor 12 toward the column-shaped/wall-shaped conductors 15 or the plate-shaped conductor 12 or that are parallel to the surface of the plate-shaped conductor 12 toward the column-shaped/wall-shaped conductors 15, through current paths shorter than the distance h to the column-shaped/wall-shaped conductor 15 or the plate-shaped conductor 12.

Currents from the parallelogram region having side lengths of L and (d−2h) in the active material layer 16 flow in the directions 19 that are perpendicular to the plate-shaped conductor 12 toward the plate-shaped conductor 12. Points (including end points) on a side (represented by a bold line) of the parallelogram region, the side being opposite the plate-shaped conductor 12, are a perpendicular distance h away from the plate-shaped conductor 12. Currents from points on the side 11 of the parallelogram region having side lengths of L and (d−2h) in the active material layer 16 flow through current paths having the distance h to the plate-shaped conductor 12.

Since currents from these points flow through the current paths having the distance h and the resistance is high, loss due to the internal resistance is not suppressed. Thus, the points (including end points) on the side opposite the plate-shaped conductor 12 are in the high-resistance region 11 (in which loss due to the internal resistance is high) (points on the bold line).

In the example illustrated in FIG. 3C, currents from all the points in the active material layer 16 between the column-shaped/wall-shaped conductors 15 facing each other except the above-described points flow through current paths having the distance h or less to the column-shaped/wall-shaped conductors 15 or the plate-shaped conductor 12.

FIG. 3D illustrates the directions 19 in which currents flow in the active material layer 16 when the column-shaped/wall-shaped conductors 15 are formed on a surface of the plate-shaped conductor 12 so as to be not perpendicular to the surface but be inclined at an angle θ with respect to the surface, and the column-shaped/wall-shaped conductors 15 are formed such that the relationship h≦D≦2h or h≦d≦2h is satisfied.

In FIG. 3D, currents from the right parallelogram region having side lengths of L and h in the active material layer 16 flow in the directions 19 perpendicular to the column-shaped/wall-shaped conductors 15 or the plate-shaped conductor 12 toward the column-shaped/wall-shaped conductors 15 or the plate-shaped conductor 12, through current paths shorter than the distance h to the column-shaped/wall-shaped conductors 15 or the plate-shaped conductor 12.

Currents from the left parallelogram region having side lengths of L and h in the active material layer 16 flow in the directions 19 that are perpendicular to the column-shaped/wall-shaped conductors 15 or the plate-shaped conductor 12 toward the column-shaped/wall-shaped conductors 15 or the plate-shaped conductor 12 or that are parallel to the surface of the plate-shaped conductor 12 toward the column-shaped/wall-shaped conductors 15, through current paths shorter than the distance h to the column-shaped/wall-shaped conductor 15 or the plate-shaped conductor 12.

In the example illustrated in FIG. 3D, currents from all the points in the active material layer 16 between the column-shaped/wall-shaped conductors 15 facing each other flow through current paths shorter than the distance h to the column-shaped/wall-shaped conductors 15 or the plate-shaped conductor 12.

In the example illustrated in FIG. 3D, the high-resistance regions 11 (in which loss due to the internal resistance is high) in FIGS. 3A and 3C are not formed. Currents from points a perpendicular distance h away from the plate-shaped conductor 12 flow through current paths shorter than the distance h to the plate-shaped conductor 12. Thus, the resistance is not high and loss due to the internal resistance can be suppressed. That is, the internal resistance of the current paths is less than the resistance corresponding to the distance h in the active material layer 16.

In the example illustrated in FIG. 3D, when d is made to be equal to h, currents from all the points in the active material layer 16 between the column-shaped/wall-shaped conductors 15 facing each other flow through current paths shorter than the distance (h/2) to the column-shaped/wall-shaped conductors 15 or the plate-shaped conductor 12. That is, the internal resistance of the current paths is less than the resistance corresponding to the distance (h/2) in the active material layer 16.

In the example illustrated in FIG. 3D, when d is made to be equal to 2h, this example is the same as the example illustrated in FIG. 3C in which the parallelogram region having side lengths of L and (d−2h) is not present.

In FIG. 3D, when the height h of the auxiliary electrodes is changed to 2h and D is made to be equal to 2h, the auxiliary electrodes having the height 2h are disposed at a center-to-center spacing equal to the height. In FIG. 3D, when the height h of the auxiliary electrodes is changed to 2h and d is made to be equal to 2h, the auxiliary electrodes having the height 2h are disposed at a spacing equal to the height.

In the case of D=2h and the case of d=2h, currents from points in the active material layer 16 having the height 2h between the auxiliary electrodes flow through current paths having the distance h or less to the auxiliary electrodes or the plate-shaped conductor 12. That is, the internal resistance of the current paths is less than the resistance corresponding to the distance h in the active material layer 16.

In an electrode in which no auxiliary electrodes are formed and an active material layer having a thickness h is formed on a surface of the plate-shaped conductor 12, current paths from points in the active material layer have the distance h or less and the internal resistance is equal to or less than the resistance corresponding to the length of the current paths. When the internal resistance of a current path having the distance h is defined as Rₕ, in the case of D=2h and the case of d=2h, the internal resistance is Rₕ or less.

Accordingly, by disposing auxiliary electrodes having a height (2H) that is twice the thickness (H=h) of the active material layer of an electrode including no auxiliary electrodes and by forming the active material layer 16 between the auxiliary electrodes, that is, by making the center-to-center spacing of the auxiliary electrodes or the spacing of the auxiliary electrodes be equal to the height of the auxiliary electrodes, a composite electrode including an active material layer having a thickness that is twice the thickness of the active material layer of an electrode including no auxiliary electrodes can be provided. In such a composite electrode, even when the volume of the active material layer 16 is increased, the internal resistance of current paths from points in the active material layer 16 to the plate-shaped conductor 12 is Rₕ or less. Thus, a high-performance composite electrode can be provided in which currents from points in the active material layer 16 can be collected without increasing the internal resistance.

Compared with an electrode in which no auxiliary electrodes are formed and an active material layer having a thickness H (=h) is formed on a surface of the plate-shaped conductor 12; in a composite electrode in which the center-to-center spacing of auxiliary electrodes or the spacing of the auxiliary electrodes is 2H and the auxiliary electrodes have a height αH (where α≧2), even when the volume of the active material layer 16 is increased, the internal resistance of current paths from points in the active material layer 16 to the plate-shaped conductor 12 is Rₕ or less. Thus, a high-performance composite electrode can be provided in which currents from points in the active material layer 16 can be collected without increasing the internal resistance.

Composite Electrode Including Column-Shaped Conductors Arranged in Square-Grid Pattern

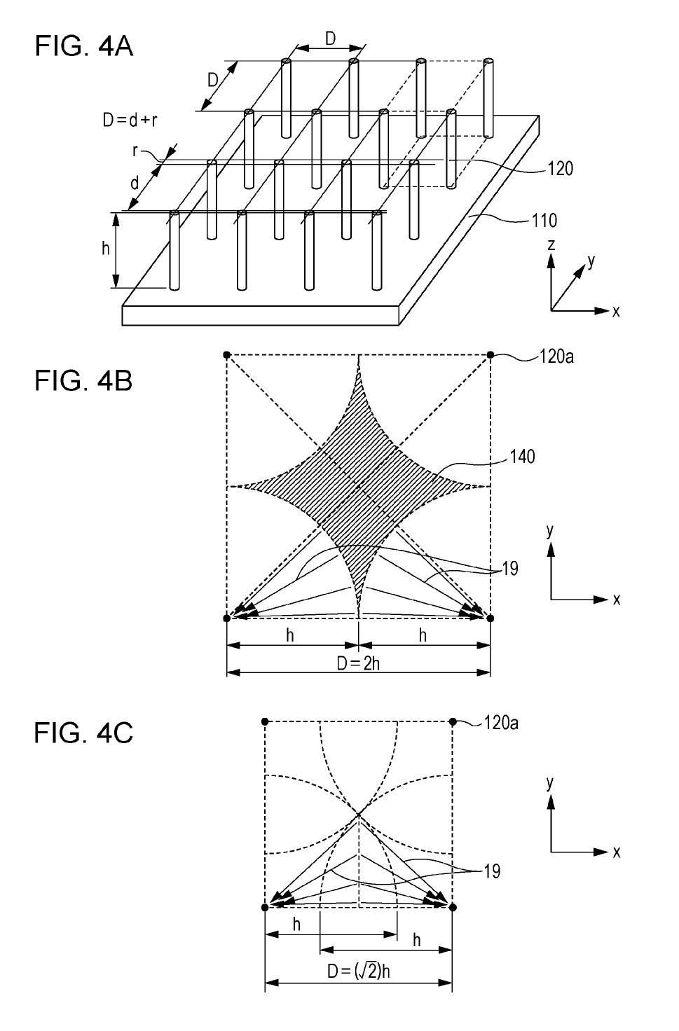

FIGS. 4A to 4C illustrate the square-grid arrangements of column-shaped conductors serving as auxiliary electrodes in composite electrodes according to an embodiment. FIG. 4A is a perspective view illustrating the square-grid arrangement of column-shaped conductors formed so as to be perpendicular to a surface of a plate-shaped conductor. FIGS. 4B and 4C are sectional views of such column-shaped conductors in terms of single square of square-grid patterns.

As illustrated in FIG. 4A, column-shaped conductors 120 having a circular section with a diameter r and having a height h are formed so as to be perpendicular to a surface of a plate-shaped conductor 110 and at a spacing d in the x and y directions on the surface of the plate-shaped conductor 110. The distance D between the central axes of the column-shaped conductors 120 is d+r. The column-shaped conductors 120 are formed with the central axes thereof being perpendicular to the surface of the plate-shaped conductor 110 such that the points at which end points of the column-shaped conductors 120 and the plate-shaped conductor 110 are connected to each other constitute four-fold axes of symmetry and a square-grid pattern, and the other end points of the column-shaped conductors 120 constitute four-fold axes of symmetry and a square-grid pattern.

The central axes of the column-shaped conductors 120 may be perpendicular to the surface of the plate-shaped conductor 110 or inclined with respect to the surface of the plate-shaped conductor 110. The column-shaped conductors 120 may be linear in the axis direction thereof or may be bent or meandering in the axis direction thereof.

FIG. 4B illustrates a sectional view parallel to the xy plane of the square grid when D is equal to 2h. FIG. 4C illustrates a sectional view parallel to the xy plane of the square grid when D is equal to (√2)h. For simplicity, in FIGS. 4B and 4C, the column-shaped conductors 120 are not illustrated but central axes 120a thereof are illustrated.

In the sectional view in FIG. 4B, points that are the distance h away from the central axes 120a of the column-shaped conductors 120 and are in a sectional plane the distance h away from the surface of the plate-shaped conductor 110 are represented by four quadrants (dotted lines). Points in the hatch region are more than the distance h away from the central axes 120a of the column-shaped conductors 120 and the distance h away from the surface of the plate-shaped conductor 110. Currents from the hatch region (including points on the circumferences of the four quadrants) in the active material layer (not shown) flow through current paths having the distance h to the plate-shaped conductor 110 or the column-shaped conductors 120.

These current paths are longer than current paths through which currents from points within the four quadrants (dotted lines) in the active material layer (not shown) flow to the plate-shaped conductor 110 or the column-shaped conductors 120. Thus, the resistance is high and loss due to the internal resistance is high. Accordingly, the hatch region is a high-resistance region (in which loss due to the internal resistance is high) 140.

The area of the high-resistance region (in which loss due to the internal resistance is high) 140 corresponds to 21.5% of the area of a single square of the square-grid pattern when the radii of the column-shaped conductors 120 are not considered and are regarded as zero.

In the sectional view in FIG. 4C, points the distance h away from the central axes 120a of the column-shaped conductors 120 in a sectional plane the distance h away from the surface of the plate-shaped conductor 110 are represented by four quadrants (dotted lines). However, in FIG. 4C, there is not the hatch region in the sectional view in FIG. 4B. Accordingly, a high loss due to the internal resistance as in the example illustrated in FIG. 4B is not caused.

In the example illustrated in FIG. 4C, since D is equal to (√2)h, currents from points in the active material layer (not shown) between the central axes 120a of the column-shaped conductors 120 flow through current paths having a distance of h/(√2) or less (0.707h or less) to the plate-shaped conductor 110 or the column-shaped conductors 120. That is, the internal resistance of the current paths is equal to or less than the resistance corresponding to the distance 0.707h in the active material layer (not shown).

As described above, when the column-shaped conductors 120 are formed so as to satisfy the relationship (√2)h≦D≦2h or (√2)h≦d≦2h, currents from points in the active material layer (not shown) except for the hatch region (in which loss due to the internal resistance is high) in the active material layer (not shown) flow through current paths shorter than the distance h to the plate-shaped conductor 110 or the column-shaped conductors 120. That is, the internal resistance of the current paths is less than the resistance corresponding to the distance h in the active material layer (not shown).

When the radii of the column-shaped conductors 120 are not considered and are regarded as zero and the relationship (√2)h≦D≦2h is satisfied, in the active material layer (not shown), currents from points that are in the region corresponding to 21.5% of the area of each single square of the square-grid pattern and are the distance h away from the surface of the plate-shaped conductor 110 flow through current paths having the distance h and currents from the other points in the active material layer (not shown) flow through current paths shorter than the distance h. That is, the internal resistance of most of the current paths is less than the resistance corresponding to the distance h in the active material layer (not shown).

When the distance d between the column-shaped conductors 120 is equal to h, currents from all the points in the active material layer (not shown) between the column-shaped conductors 120 flow through current paths having a distance (h/2) or less to the column-shaped conductors 120 or the plate-shaped conductor 110. That is, the internal resistance of the current paths is equal to or less than the resistance corresponding to the distance (h/2) in the active material layer (not shown).

Compared with the electrode in FIG. 1D in which no auxiliary electrodes are formed and the active material layer 16 having a thickness H is formed on the surface of the plate-shaped conductor 12 (the internal resistance of the current paths from points in the active material layer 16 is equal to or less than R_{H} corresponding to the distance H); in FIG. 4B, in a composite electrode in which the auxiliary electrodes (column-shaped conductors 120) have a height αH (where α≧1), H is equal to h, and the spacing d of the auxiliary electrodes satisfy H≦d≦2H, the internal resistance of current paths from points in circular regions having a radius h from the central axes 120a of the column-shaped conductors 120 in the active material layer (not shown) to the plate-shaped conductor 110 is equal to or less than R_{H}, whereas the internal resistance of current paths from points in the high-resistance region (in which loss due to the internal resistance is high) 140 that is more than the height h away from the plate-shaped conductor 110 in the active material layer (not shown) to the plate-shaped conductor 110 is more than R_{H}.

In FIG. 4C, in a composite electrode in which the auxiliary electrodes (column-shaped conductors 120) have a height αH (where α≧1), H is equal to h, and the spacing d of the auxiliary electrodes satisfy H≦d≦2H, the internal resistance of current paths from points in the active material layer (not shown) between the auxiliary electrodes to the plate-shaped conductor 110 is R_{H} or less.

Composite Electrode Including Column-Shaped Conductors Arranged in Hexagonal-Grid Pattern

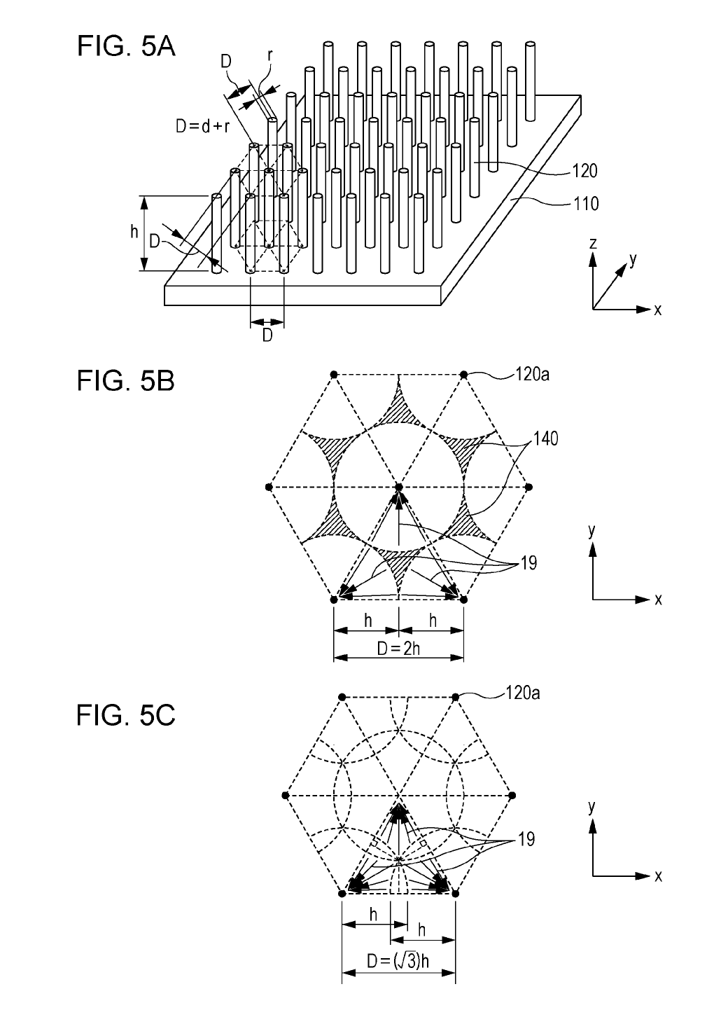

FIGS. 5A to 5C illustrate other arrangements of column-shaped conductors serving as auxiliary electrodes in composite electrodes according to an embodiment. Specifically, FIG. 5A is a perspective view illustrating the hexagonal-grid arrangement of column-shaped conductors formed so as to be perpendicular to a surface of a plate-shaped conductor. FIGS. 5B and 5C are sectional views of such column-shaped conductors in terms of single hexagon of hexagonal-grid patterns.

As illustrated in FIG. 5A, instead of the example in FIG. 4A, the column-shaped conductors of a composite electrode may be arranged in the following manner. The column-shaped conductors 120 are formed with the central axes thereof being perpendicular to the surface of the plate-shaped conductor 110 such that the points at which end points of the column-shaped conductors 120 and the plate-shaped conductor 110 are connected to each other constitute six-fold axes of symmetry and a hexagonal-grid pattern and the other end points of the column-shaped conductors 120 constitute six-fold axes of symmetry and a hexagonal-grid pattern. The distance D between the central axes of the column-shaped conductors 120 is d+r.

The central axes of the column-shaped conductors 120 may be perpendicular to the surface of the plate-shaped conductor 110 or inclined with respect to the surface of the plate-shaped conductor 110. The column-shaped conductors 120 may be linear in the axis direction thereof or may be bent or meandering in the axis direction thereof.

FIG. 5B illustrates a sectional view parallel to the xy plane of the hexagonal grid when D is equal to 2h. FIG. 5C illustrates a sectional view parallel to the xy plane of the hexagonal grid when D is equal to (√3)h. For simplicity, in FIGS. 5B and 5C, the column-shaped conductors 120 are not illustrated but central axes 120a thereof are illustrated.

In the sectional view in FIG. 5B, points that are the distance h away from the central axes 120a of the column-shaped conductors 120 and are in a sectional plane the distance h away from the surface of the plate-shaped conductor 110 are represented by a circle and six one-third circles (dotted lines). Points in the hatch region are beyond the distance h from the central axes 120a of the column-shaped conductors 120 but at the distance h from the surface of the plate-shaped conductor 110. Currents from the hatch region (including points on the circumferences of the circle and the six one-third circles (dotted lines)) in the active material layer (not shown) flow through current paths having the distance h to the plate-shaped conductor 110 or the column-shaped conductors 120.

These current paths are longer than current paths through which currents from points in the active material layer (not shown) within the circle and the six one-third circles (dotted lines) flow to the plate-shaped conductor 110 or the column-shaped conductors 120. Thus, the resistance is high and loss due to the internal resistance is high. Accordingly, the hatch region is a high-resistance region (in which loss due to the internal resistance is high) 140.

The area of the high-resistance region (in which loss due to the internal resistance is high) 140 corresponds to 9.3% of the area of a single hexagon of the hexagonal-grid pattern when the radii of the column-shaped conductors 120 are not considered and are regarded as zero.

In the sectional view in FIG. 5C, points that are the distance h away from the central axes 120a of the column-shaped conductors 120 and are in a sectional plane the distance h away from the surface of the plate-shaped conductor 110 are represented by a circle (dotted line) and six one-third circles (dotted lines). However, in FIG. 5C, there is not the hatch region in the sectional view in FIG. 5B. Accordingly, a high loss due to the internal resistance as in the example illustrated in FIG. 5B is not caused.

In the example illustrated in FIG. 5C, since D is equal to (√3)h, currents from points in the active material layer (not shown) between the central axes 120a of the column-shaped conductors 120 flow through current paths having a distance of (√3)h/2 or less (0.866h or less) to the plate-shaped conductor 110 or the column-shaped conductors 120. That is, the internal resistance of the current paths is equal to or less than the resistance corresponding to the distance 0.866h in the active material layer (not shown).

As described above, when the column-shaped conductors 120 are formed so as to satisfy the relationship (√3)h≦D≦2h or (√3)h≦d≦2h, currents from points in the active material layer (not shown) except for the hatch region (in which loss due to the internal resistance is high) flow through current paths shorter than the distance h to the plate-shaped conductor 110 or the column-shaped conductors 120. That is, the internal resistance of the current paths is less than the resistance corresponding to the distance h in the active material layer (not shown).

When the radii of the column-shaped conductors 120 are not considered and are regarded as zero and the relationship (√3)h≦D≦2h is satisfied, in the active material layer (not shown), currents from points that are in the region corresponding to 9.3% of the area of each single hexagon of the hexagonal-grid pattern and are the distance h away from the surface of the plate-shaped conductor 110 flow through current paths having the distance h and currents from the other points in the active material layer (not shown) flow through current paths shorter than the distance h. That is, the internal resistance of most of the current paths is less than the resistance corresponding to the distance h in the active material layer (not shown).

When the distance d between the column-shaped conductors 120 is equal to h, currents from all the points in the active material layer (not shown) between the column-shaped conductors 120 flow through current paths having a distance (h/2) or less to the column-shaped conductors 120 or the plate-shaped conductor 110. That is, the internal resistance of the current paths is equal to or less than the resistance corresponding to the distance (h/2) in the active material layer (not shown).

Compared with the electrode in FIG. 1D in which no auxiliary electrodes are formed and the active material layer 16 having a thickness H is formed on the surface of the plate-shaped conductor 12 (the internal resistance of the current paths from points in the active material layer 16 is equal to or less than R_{H} corresponding to the distance H); in FIG. 5B, in a composite electrode in which the auxiliary electrodes (column-shaped conductors 120) have a height αH (where α≧1), H is equal to h, and the spacing d of the auxiliary electrodes satisfy H≦d≦2H, the internal resistance of current paths from points in the active material layer (not shown) in circular regions having a radius h from the central axes 120a of the column-shaped conductors 120 to the plate-shaped conductor 110 is equal to or less than R_{H}, whereas the internal resistance of current paths from points in the active material layer (not shown) in the high-resistance region (in which loss due to the internal resistance is high) 140 that is more than the height h away from the plate-shaped conductor 110 to the plate-shaped conductor 110 is more than R_{H}.

In FIG. 5C, in a composite electrode in which the auxiliary electrodes (column-shaped conductors 120) have a height αH (where α≧1), H is equal to h, and the spacing d of the auxiliary electrodes satisfy H≦d≦2H, the internal resistance of current paths from points in the active material layer (not shown) between the auxiliary electrodes to the plate-shaped conductor 110 is R_{H} or less.

Formation of Column-Shaped Conductors

The column-shaped conductors 120 in FIGS. 4A to 4C and 5A to 5C and FIGS. 10A1, 10A2, and 10C described below may be formed of, for example, carbon nanotubes or a metal in the following manner. The shape of a section (perpendicular to the axial direction) of the column-shaped conductors 120 may be any shape such as a circle, an ellipse, a square, or a rectangle.

The column-shaped conductors 120 serving as auxiliary electrodes and formed of carbon nanotubes may be formed on a surface of the plate-shaped conductor 110 in the following manner. To form the column-shaped conductors 120 so as to have a desired sectional shape and be arranged in a desired pattern on a surface of the plate-shaped conductor 110, catalytic metal fine particles serving as cores for the growth of carbon nanotubes are formed in a patterned region of the surface of the plate-shaped conductor 110.

Specifically, for example, a metal serving as a catalyst is deposited onto the surface of the plate-shaped conductor 110 by sputtering or the like through a mask formed so as to have openings that have shapes corresponding to the desired sectional shape and are arranged in the desired pattern. As a result, a catalytic metal thin layer is formed on the patterned region so as to have a desired thickness. Examples of the metal serving as a catalyst include Fe, Pd, Co, Ni, W, Mo, Mn, and alloys of the foregoing.

By heating the catalytic metal thin layer at a high temperature, catalytic metal fine particles (the size of the catalytic metal fine particles is determined by the thickness of the catalytic metal thin layer) are formed in the patterned region. In the region in which the catalytic metal fine particles are formed, the column-shaped conductors 120 each of which is a structure constituted by a plurality of carbon nanotubes perpendicularly grown may be formed by a chemical vapor deposition (CVD) method or the like.

The column-shaped conductors 120 serving as auxiliary electrodes and formed of a metal may be formed in the following manner. An insulating film is formed on a surface of the plate-shaped conductor 110. This insulating film is patterned so as to have openings that have a desired shape and are arranged in a desired pattern. The openings are filled with a metal such as an Al alloy or Cu by a sputtering method, a CVD method, a plating method, or the like. Then, the insulating film is removed by a chemical-mechanical polishing (CMP) method or the like. As a result, metal columns (column-shaped conductors 120) having a desired height h can be formed so as to be arranged in the desired pattern.

Alternatively, a metal film (having a desired thickness h) is formed of an Al alloy, Cu, or the like on a surface of the plate-shaped conductor 110. This metal film is etched through a mask with which metal columns (column-shaped conductors 120) that have a desired sectional shape and are arranged in a desired pattern can be formed. As a result, metal columns (column-shaped conductors 120) that have the desired sectional shape, are arranged in the desired pattern, and have the desired height h can be formed.

Composite Electrode Including Wall-Shaped Conductors

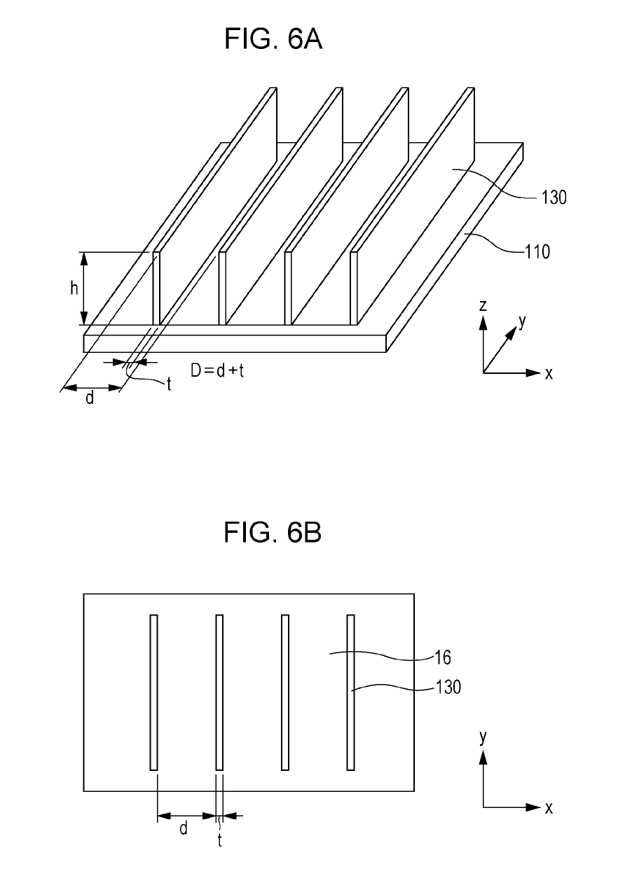

FIGS. 6A and 6B illustrate the arrangement of wall-shaped conductors serving as auxiliary electrodes in a composite electrode according to an embodiment. FIG. 6A is a perspective view and FIG. 6B is a plan view.

As illustrated in FIG. 6A, wall-shaped conductors 130 are formed on a surface of the plate-shaped conductor 110. As illustrated in FIG. 6B, the gaps between the wall-shaped conductors 130 are filled with an active material to thereby form the active material layer 16.

As illustrated in FIG. 6A, the wall-shaped conductors 130 having a wall thickness t and a height h are formed at a spacing d in the x direction on the surface of the plate-shaped conductor 110. The wall-shaped conductors 130 are formed so as to satisfy the relationship h≦D≦2h or h≦d≦2h. The wall-shaped conductors 130 are formed of a material having a lower electrical resistance than the active material layer 16. The distance D between the wall thickness central planes of the wall-shaped conductors 130 is d+t. The wall-shaped conductors 130 are formed on the surface of the plate-shaped conductor 110 such that the wall thickness central planes thereof are perpendicular to the surface of the plate-shaped conductor 110.

In the example illustrated in FIGS. 6A and 6B, the wall-shaped conductors 130 are formed such that the wall thickness central planes thereof are perpendicular to the surface of the plate-shaped conductor 110. However, the wall-shaped conductors 130 may be formed such that the wall thickness central planes thereof are inclined with respect to the surface of the plate-shaped conductor 110.

Although the wall thickness central planes of the wall-shaped conductors 130 in FIG. 6A are parallel to the zy plane, the wall thickness central planes may be non-parallel to the zy plane. The wall thickness central planes of the wall-shaped conductors 130 formed on the surface of the plate-shaped conductor 110 may be irregularly shaped in the z direction and/or the y direction to constitute meandering planes.

Compared with the electrode in FIG. 1D in which no auxiliary electrodes are formed and the active material layer 16 having a thickness H is formed on the surface of the plate-shaped conductor 12 (the internal resistance of the current paths from points in the active material layer 16 is equal to or less than R_{H} corresponding to the distance H); in FIG. 6B, in a composite electrode in which the auxiliary electrodes (wall-shaped conductors 130) have a height αH (where α≧1), H is equal to h, and the spacing d of the auxiliary electrodes satisfy H≦d≦2H, the internal resistance of current paths from points in the active material layer 16 between the auxiliary electrodes to the plate-shaped conductor 110 is equal to or less than R_{H}.

Composite Electrode Including Honeycomb Conductor

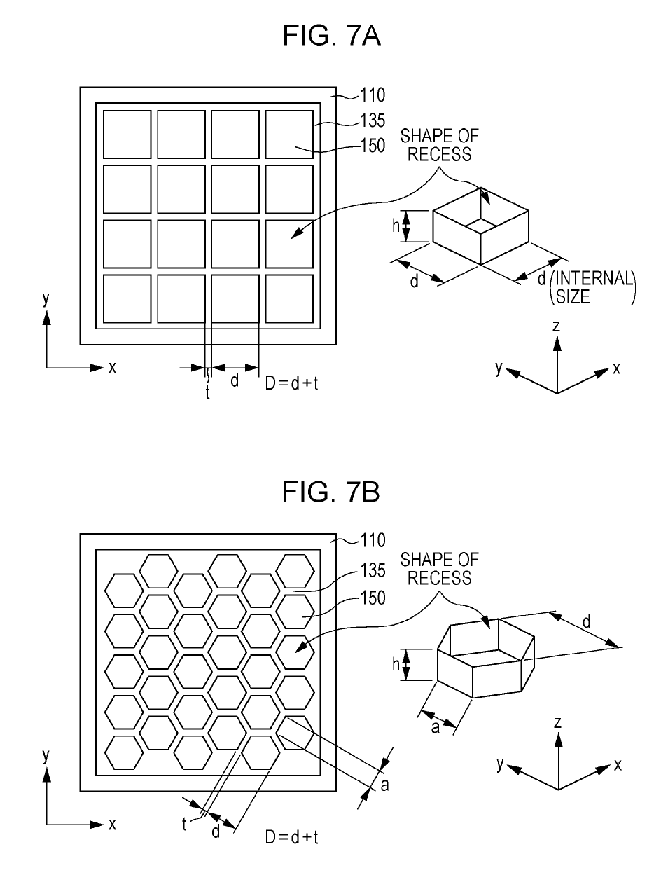

FIGS. 7A and 7B are other arrangements of wall-shaped conductors serving as auxiliary electrodes in composite electrodes according to an embodiment: specifically, examples of the structure of a composite electrode including a honeycomb conductor. FIG. 7A is a plan view and a perspective view that illustrate the structure of a honeycomb conductor including recesses having a square section. FIG. 7B is a plan view and a perspective view that illustrate the structure of a honeycomb conductor including recesses having a regular hexagonal section.

FIG. 7A illustrates, as an example, the structure of a honeycomb conductor including recesses 150 having a square section parallel to the surface of the plate-shaped conductor 110. In this composite electrode, a honeycomb conductor 135 that has a height h and a wall thickness t and has through holes having an internal size d is bonded to the surface of the plate-shaped conductor 110; and the recesses 150 are filled with an active material. The honeycomb conductor 135 is formed such that the center-to-center distance D of the walls is (d+t) and the relationship (√2)h≦D≦2h or (√2)h≦d≦2h is satisfied.

FIG. 7B illustrates, as an example, the structure of a honeycomb conductor including recesses 150 having a regular hexagonal section parallel to the surface of the plate-shaped conductor 110. In this composite electrode, a honeycomb conductor 135 that has a height h and a wall thickness t and has through holes having walls facing each other at a spacing d and having an internal side length a, is bonded to the surface of the plate-shaped conductor 110; and the recesses 150 are filled with an active material. The honeycomb conductor 135 is formed such that the center-to-center distance D of the walls is (d+t) and the relationship (√3)h≦D≦2h or (√3)h≦d≦2h is satisfied.

In the examples illustrated in FIGS. 7A and 7B, the walls facing each other at the spacing d are formed so as to be perpendicular to the surface of the plate-shaped conductor 110. Alternatively, the walls facing each other at the spacing d may be formed so as to be inclined with respect to the surface of the plate-shaped conductor 110.

Compared with the electrode in FIG. 1D in which no auxiliary electrodes are formed and the active material layer 16 having a thickness H is formed on the surface of the plate-shaped conductor 12 (the internal resistance of the current paths from points in the active material layer 16 is equal to or less than R_{H} corresponding to the distance H); in FIGS. 7A and 7B in a composite electrode in which the auxiliary electrodes (wall-shaped conductor 135) have a height αH (where α≧1), H is equal to h, and the spacing d of the auxiliary electrodes satisfy H≦d≦2H, the internal resistance of current paths from points in the active material layer (not shown) between the auxiliary electrodes to the plate-shaped conductor 110 is equal to or less than R_{H}.

Formation of Wall-Shaped Conductors

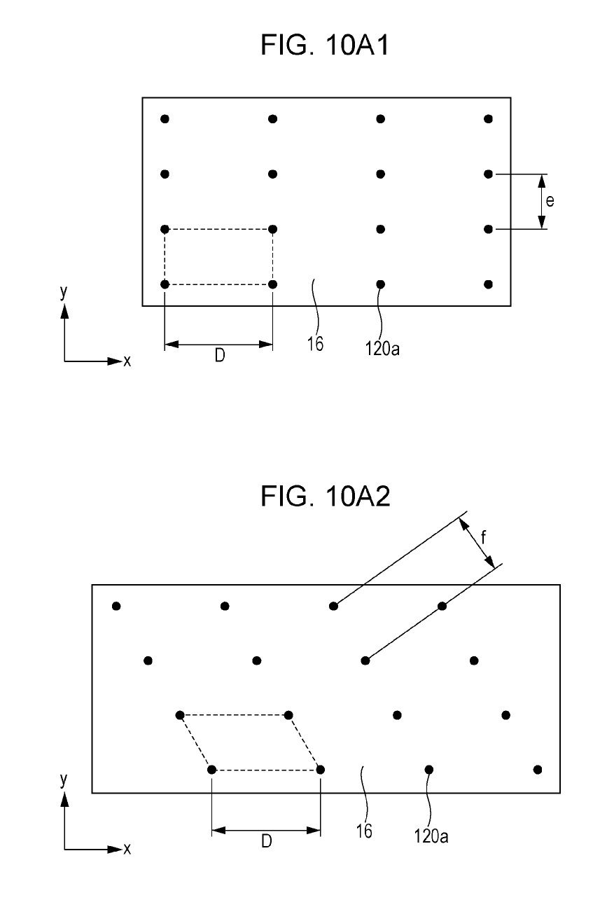

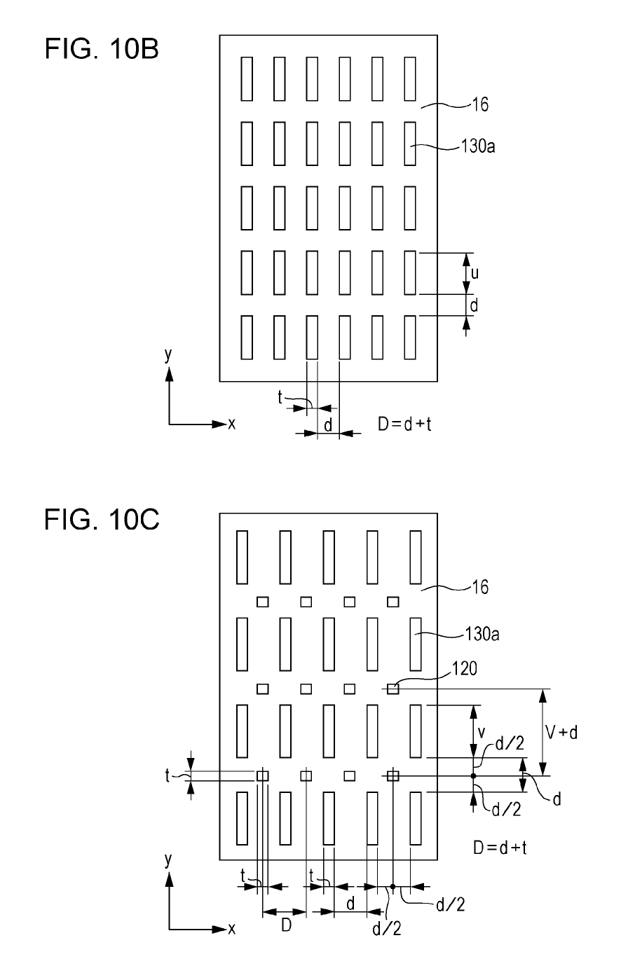

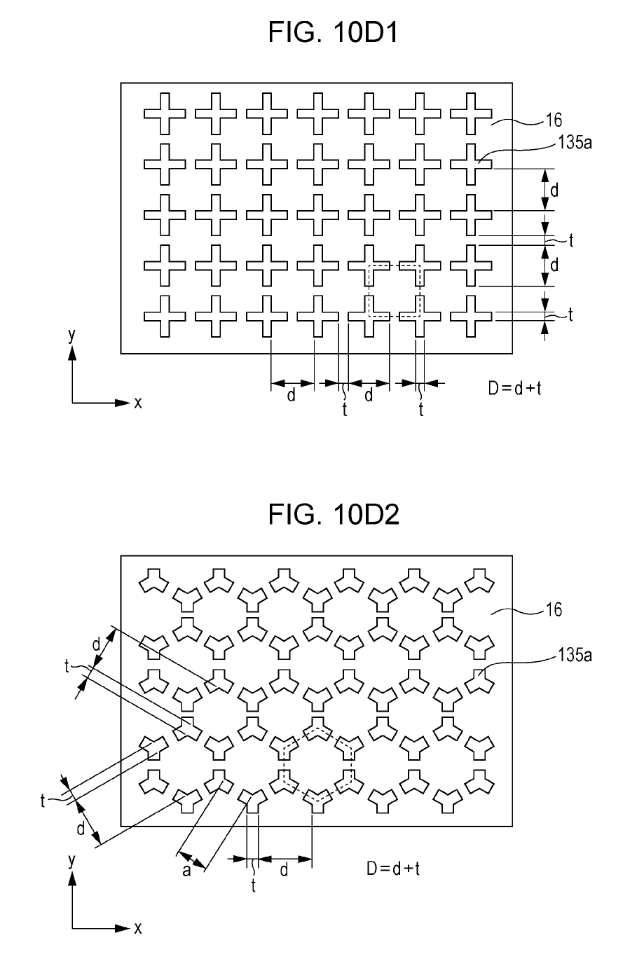

The wall-shaped conductors 130 and the honeycomb conductors 135 in FIGS. 6A to 7B and wall-shaped conductor parts 130a and honeycomb conductor parts 135a in FIGS. 10B to 10D2 described below may be formed of, for example, carbon nanotubes or a metal on a surface of the plate-shaped conductor 110 in the following manner.

The wall-shaped conductors 130, the honeycomb conductors 135, the wall-shaped conductor parts 130a, and the honeycomb conductor parts 135a serving as auxiliary electrodes and formed of carbon nanotubes may be formed on a surface of the plate-shaped conductor 110 in the following manner. To form such wall-shaped conductors so as to have a desired sectional shape and be arranged in a desired pattern on a surface of the plate-shaped conductor 110, catalytic metal fine particles serving as cores for the growth of carbon nanotubes are formed in a patterned region of the surface of the plate-shaped conductor 110.

Specifically, for example, a metal serving as a catalyst is deposited onto the surface of the plate-shaped conductor 110 by sputtering or the like through a mask formed so as to have openings that have shapes corresponding to the desired sectional shape and are arranged in the desired pattern. As a result, a catalytic metal thin layer is formed on the patterned region so as to have a desired thickness. Examples of the metal serving as a catalyst include Fe, Pd, Co, Ni, W, Mo, Mn, and alloys of the foregoing.

By heating the catalytic metal thin layer at a high temperature, catalytic metal fine particles (the size of the catalytic metal fine particles is determined by the thickness of the catalytic metal thin layer) are formed in the patterned region. In the region in which the catalytic metal fine particles are formed, the wall-shaped conductors each of which is a structure constituted by a plurality of carbon nanotubes perpendicularly grown may be formed by a chemical vapor deposition (CVD) method or the like.

The wall-shaped conductors 130, the honeycomb conductors 135, the wall-shaped conductor parts 130a, and the honeycomb conductor parts 135a serving as auxiliary electrodes and formed of a metal may be formed in the following manner. An insulating film is formed on a surface of the plate-shaped conductor 110. This insulating film is patterned so as to have openings that have a desired shape and are arranged in a desired pattern for the wall-shaped conductors 130, the honeycomb conductors 135, the wall-shaped conductor parts 130a, or the honeycomb conductor parts 135a. The openings are filled with a metal such as an Al alloy or Cu by a sputtering method, a CVD method, a plating method, or the like. Then, the insulating film is removed by a chemical-mechanical polishing (CMP) method or the like. As a result, the wall-shaped conductors 130, the honeycomb conductors 135, the wall-shaped conductor parts 130a, or the honeycomb conductor parts 135a having a desired height h can be formed so as to be arranged in the desired pattern.

Alternatively, a metal film (having a desired thickness h) may be formed of an Al alloy, Cu, or the like on a surface of the plate-shaped conductor 110. This metal film is etched through a mask with which the wall-shaped conductors 130, the honeycomb conductors 135, the wall-shaped conductor parts 130a, or the honeycomb conductor parts 135a that have a desired sectional shape and are arranged in a desired pattern can be formed. As a result, the wall-shaped conductors 130, the honeycomb conductor 135, the wall-shaped conductor parts 130a, or the honeycomb conductor parts 135a that have the desired sectional shape, are arranged in the desired pattern, and have the desired height h can be formed.

Electric Double Layer Capacitor Including Composite Electrode as Polarizable Electrode

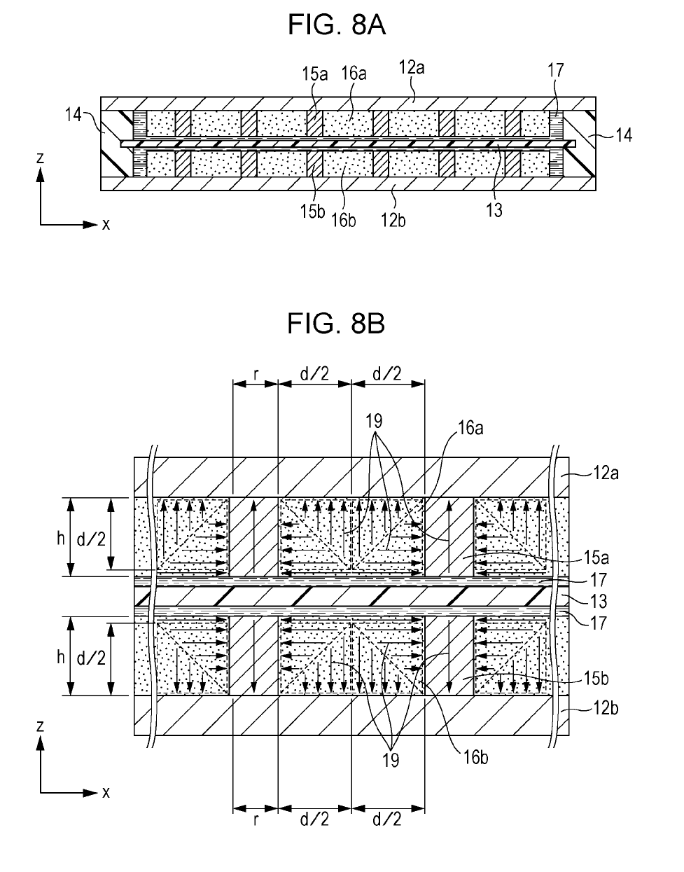

FIGS. 8A and 8B are sectional views illustrating the schematic structures of an electric double layer capacitor according to an embodiment. FIG. 8A illustrates the whole structure of the electric double layer capacitor and FIG. 8B is a partial enlarged view illustrating directions 19 in which currents flow in porous carbon.

As illustrated in FIG. 8A, an electric double layer capacitor (EDLC) is constituted by a polarizable electrode (positive electrode) 10a; a polarizable electrode (negative electrode) 10b; a separator 13 disposed between the polarizable electrode (positive electrode) 10a and the polarizable electrode (negative electrode) 10b; a positive electrode collector 12a bonded to the polarizable electrode (positive electrode) 10a; a negative electrode collector 12b bonded to the polarizable electrode (negative electrode) 10b; an electrolytic solution 17; and a gasket 14 that is insoluble in and resistant to the electrolytic solution 17 and used for filling gaps between the separator 13 and the polarizable electrodes 10a and 10b, preventing the electrolytic solution 17 from leaking, and sealing the capacitor. The positive electrode collector 12a and the negative electrode collector 12b correspond to the plate-shaped conductor 12 (FIGS. 1A to 3D) or the plate-shaped conductor 110 (FIGS. 4A to 7B).

Polarizable Electrodes

The polarizable electrode (positive electrode) 10a includes porous carbon 16a serving as an active material and auxiliary electrodes including carbon nanotubes 15a. The polarizable electrode (negative electrode) 10b includes porous carbon 16b serving as an active material and auxiliary electrodes including carbon nanotubes 15b.

The gaps between the carbon nanotubes 15a formed so as to be connected to the positive electrode collector 12a are filled with the porous carbon 16a. The gaps between the carbon nanotubes 15b formed so as to be connected to the negative electrode collector 12b are filled with the porous carbon 16b.

The porous carbon 16a, the porous carbon 16b, and the separator 13 are impregnated with the electrolytic solution 17 prepared by dissolving an electrolyte in a nonprotic solvent. Charge is stored at the interface (electric double layer) between the porous carbon 16a, the porous carbon 16b, and the electrolytic solution 17 and electric energy is stored.

The porous carbons 16a and 16b are composed of a conductive carbon material. Examples of the conductive carbon material include carbon blacks such as acetylene black, channel black, furnace black, lamp black, and thermal black; activated carbons formed from charcoal, coal, and the like; carbon fibers prepared by carbonizing synthetic fibers, petroleum pitch materials, and the like; burnt products of organic resins such as phenolic resins; and powdered products of coke and the like.

In the formation of the polarizable electrodes 10a and 10b, the porous carbons 16a and 16b are used together with a conductive auxiliary agent and a binder.

The conductive auxiliary agent is used for the purpose of aiding the electrical contact between the porous carbons 16a and 16b to thereby enhance conductivity and formability of the electrodes. Examples of the conductive auxiliary agent include graphite carbon materials such as carbon black and natural graphite; fine particles and fibers of metals such as Al, Ni, Cu, Ag, Au, and Pt; fine particles of conductive metal oxides (ruthenium oxide, titanium oxide, and the like); and conductive polymers such as polyaniline, polypyrrole, polythiophene, polyacetylene, and polyacene.

Examples of the binder include fluorine-containing resins such as polyvinylidene fluoride (PVdF), hexafluoropropylene (HFP), chlorotrifluoroethylene (CTFE), and polytetrafluoroethylene (PTFE); polyethylene; and polypropylene.

Carbon Nanotubes

The carbon nanotubes 15a and 15b that are column-shaped conductors serving as auxiliary electrodes may be formed on surfaces of the collectors (positive electrode collector 12a and negative electrode collector 12b) in, for example, the following manner. To form the column-shaped conductors so as to have a desired sectional shape and be arranged in a desired pattern on the surfaces of the collectors, catalytic metal fine particles serving as cores for the growth of carbon nanotubes are formed in patterned regions of the surfaces of the collectors.

Specifically, for example, a metal serving as a catalyst is deposited onto the surfaces of the collectors by sputtering or the like through a mask formed so as to have openings that have shapes corresponding to the desired sectional shape and are arranged in the desired pattern. As a result, catalytic metal thin layers are formed on the patterned regions so as to have a desired thickness. Examples of the metal serving as a catalyst include Fe, Pd, Co, Ni, W, Mo, Mn, and alloys of the foregoing.

By heating the catalytic metal thin layers at a high temperature, catalytic metal fine particles (the size of the atalytic metal fine particles is determined by the thickness of the catalytic metal thin layers) are formed in the patterned regions. In the regions in which the catalytic metal fine particles are formed, the column-shaped conductors each of which is a structure constituted by a plurality of carbon nanotubes perpendicularly grown may be formed by a chemical vapor deposition (CVD) method or the like.

Electrolytic Solution

Examples of the electrolyte include ion dissociation salts such as onium salts: tetraalkylammonium salts such as (C₂H₅)₄NBF₄, (C₂H₅)₄NPF₄, (C₂H₅)₄NClO₄, (C₂H₅)₃CH₃NBF₄, and (CH₃)₄NBF₄; quaternary ammonium salts including alkylene groups; phosphonium salts; and ammonium halide salts in which at least one hydrogen atom in an alkyl group or an alkylene group of the foregoing salts is substituted with a halogen atom such as a fluorine atom.

Examples of the nonprotic solvent include cyclic carbonates such as ethylene carbonate, propylene carbonate, and butylene carbonate; linear carbonates such as dimethyl carbonate, ethyl methyl carbonate, and diethyl carbonate; cyclic carboxylates such as γ-butyrolactone and γ-valerolactone; linear carboxylates such as methyl acetate and methyl propionate; nitriles such as acetonitrile, glutaronitrile, adiponitrile, methoxyacetonitrile, and 3-methoxypropiononitrile; sulfolane; and trimethylphosphate.

Separator

The separator 13 has a high ion permeability and is insoluble in the electrolyte and resistant to corrosion by the electrolyte. The separator 13 is constituted by a porous film, a nonwoven fabric, a sheet, or the like composed of cellulose, polyester, polyphenylene sulfide, polyethylene terephthalate, polybutylene terephthalate, polyamide, polyimide, a fluorocarbon resin, a polyolefin resin such as polypropylene or polyethylene, glass fiber, a ceramic, or the like. The separator 13 is impregnated with the electrolytic solution 17. The separator 13 prevents short circuits between the polarizable electrode (positive electrode) 10a and the polarizable electrode (negative electrode) 10b. The separator 13 has porous paths through which electrolytic ions migrate.

Collectors

The positive electrode collector 12a and the negative electrode collector 12b may be composed of, for example, a metal such as nickel, aluminum, titanium, copper, gold, silver, platinum, an aluminum alloy, or a stainless steel, or another conductive material.

Gasket

The gasket 14 is composed of, for example, polypropylene, polyphenylene sulfide, polyethylene terephthalate, polyamide, a tetrafluoroethylene-perfluoroalkyl vinyl ether copolymer resin (PFA), a poly(ether ether ketone) (PEEK) resin, a polyether sulfone resin, or a fluorocarbon resin.

FIG. 8B is a partial enlarged sectional view illustrating the schematic structure of an electric double layer capacitor according to an embodiment and directions in which currents flow. Specifically, FIG. 8B illustrates directions in which currents flow in the active material layers (porous carbons 16a and 16b) of the electric double layer capacitor being charged in which a negative electric potential is applied to the positive electrode collector 12a and a positive electric potential is applied to the negative electrode collector 12b.

As illustrated in FIG. 8B, column-shaped conductors (carbon nanotubes 15a and 15b) are formed on surfaces of the collectors (positive electrode collector 12a and negative electrode collector 12b) so as to satisfy the relationship h≦D≦2h or h≦d≦2h. Currents from two square regions having a side length of (d/2) in the active material layers (porous carbons 16a and 16b) flow in the directions 19 that are perpendicular to the carbon nanotubes 15a and 15b or the collectors (positive electrode collector 12a and negative electrode collector 12b) toward the carbon nanotubes 15a and 15b or the collectors (positive electrode collector 12a and negative electrode collector 12b). Currents from a rectangular region having a long-side length of d and a short-side length of (h−(d/2)) in the active material layers (porous carbons 16a and 16b) flow in the directions 19 that are perpendicular to the carbon nanotubes 15a or 15b toward the carbon nanotubes 15a or 15b.

When the carbon nanotubes 15a and 15b are not provided, currents from the active material layers (porous carbons 16a and 16b) in regions that are a distance h or less away from the collectors (positive electrode collector 12a and negative electrode collector 12b) flow in the directions 19 that are perpendicular to the collectors toward the collectors.

In the example illustrated in FIGS. 8A and 8B, the carbon nanotubes 15a and 15b are provided and the relationship D≦2h is satisfied and hence the relationship (d/2)<h is satisfied. Accordingly, currents from the active material layers (porous carbons 16a and 16b) flow through the shortest current paths, which provides a low resistance, to the carbon nanotubes 15a or 15b or the collectors (positive electrode collector 12a and negative electrode collector 12b). Thus, loss due to the internal resistance can be suppressed.

Accordingly, in the example illustrated in FIGS. 8A and 8B, since currents from points that are a perpendicular distance h away from the collectors (positive electrode collector 12a and negative electrode collector 12b) flow through current paths shorter than the distance h to the collectors and hence a high resistance is not caused.

Solid-State Lithium-Ion Battery Including Composite Electrode as Active Material Electrode

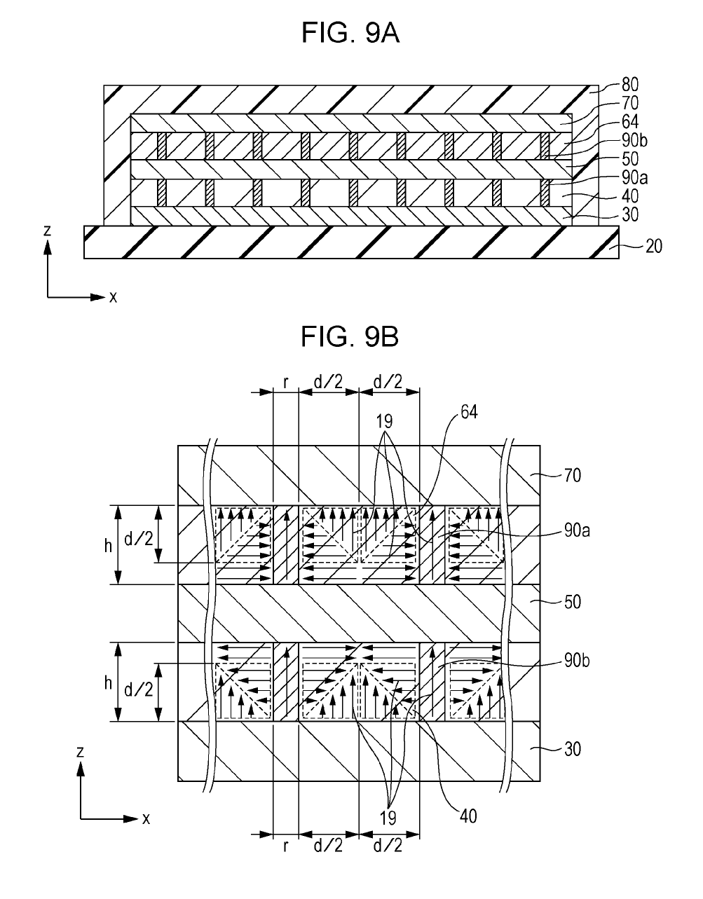

FIGS. 9A and 9B are sectional views illustrating the schematic structures of a lithium-ion battery according to an embodiment. Specifically, FIG. 9A illustrates the whole structure of the battery and FIG. 9B is a partial enlarged view illustrating directions in which currents flow in the negative electrode active material layer and the positive electrode active material layer.

As illustrated in FIG. 9A, the lithium-ion battery includes a laminated body including a positive electrode collector layer 30, a positive electrode active material layer 40, an electrolytic layer 50, a negative electrode active material layer 64, and a negative electrode collector layer 70 that are sequentially stacked on an electrical insulating substrate 20. A whole protective layer 80 composed of, for example, an ultraviolet curable resin, is formed so as to cover the entirety of the laminated body. The positive electrode collector layer 30 and the negative electrode collector layer 70 correspond to the plate-shaped conductor 12 (FIGS. 1A to 3D) or the plate-shaped conductor 110 (FIGS. 4A to 7B).

The gaps between carbon nanotubes 90a formed so as to be connected to the negative electrode collector layer 70 are filled with the negative electrode active material layer 64. The gaps between carbon nanotubes 90b formed so as to be connected to the positive electrode collector layer 30 are filled with the positive electrode active material layer 40.

The layer configuration of the lithium-ion battery illustrated in FIG. 9A is electrical insulating substrate/positive electrode collector layer/positive electrode active material layer/electrolytic layer/negative electrode active material layer/negative electrode collector layer/whole protective layer. The electrolytic layer may be composed of a solid electrolyte or a gel electrolyte.

A lithium-ion battery may have a configuration in which a plurality of the laminated bodies are sequentially stacked on the electrical insulating substrate 20, are electrically connected in series, and are covered with the whole protective layer 80. Alternatively, a lithium-ion battery may have another configuration in which a plurality of the laminated bodies are arranged side by side on the electrical insulating substrate 20, are electrically connected in parallel or in series, and are covered with the whole protective layer 80.

Another layer configuration may be employed for the laminated body. Specifically, the negative electrode collector layer 70, the negative electrode active material layer 64, the electrolytic layer 50, the positive electrode active material layer 40, and the positive electrode collector layer 30 are sequentially stacked on the electrical insulating substrate 20. That is, a battery may have such a layer configuration of electrical insulating substrate/negative electrode collector layer/negative electrode active material layer/electrolytic layer/positive electrode active material layer/positive electrode collector layer/whole protective layer.

Electrical Insulating Substrate

Examples of the electrical insulating substrate 20 include inorganic insulating substrates and organic insulating substrates such as a polycarbonate (PC) resin substrate, a fluorocarbon resin substrate, a polyethylene terephthalate (PET) substrate, a polybutylene terephthalate (PBT) substrate, a polyimide (PI) substrate, a polyether sulfone (PES) substrate, a polyphenylene sulfide (PPS) substrate, and a poly(ether ether ketone) (PEEK) substrate.

Positive Electrode Active Material Layer

The positive electrode active material layer 40 may be formed of LiMnO₂, LiMn₂O₄, Li₂Mn₂O₄, LiCoO₂, LiCO₂O₄, LiNiO₂, LiNi₂O₄, LiMnCoO₄, V₂O₅, MnO₂, Li₄Ti₅O₁₂, LiTi₂O₄, LiFePO₄, or the like.

When the negative electrode active material layer 64 and the positive electrode active material layer 40 are formed of materials other than elemental metals, such as oxides, the negative electrode active material layer 64 and the positive electrode active material layer 40 may be formed by subjecting the collectors (positive electrode collector layer 30 and negative electrode collector layer 70) on which column-shaped conductors (for example, carbon nanotubes 90a and 90b) have been formed to a thin-film formation process such as sputtering.

Negative Electrode Active Material Layer

The negative electrode active material layer 64 may be formed of, for example, metal lithium, a lithium alloy (for example, a lithium alloy containing Al, Zn, Pb, Si, Sn, Mg, In, Ca, or Sb), a Si alloy (for example, a Si alloy containing any one of Sn, Ni, Cu, Fe, Co, Mn, Zn, In, Ag, Ti, Ge, Bi, Sb, and Cr), a Sn alloy (for example, a Sn alloy containing any one of Si, Ni, Cu, Fe, Co, Mn, Zn, In, Ag, Ti, Ge, Bi, Sb, and Cr), a metal sulfide (for example, NiS, MoS, LiTiS₂, or the like), a metal oxide (for example, iron oxide (e.g., FeO₂), tungsten oxide (WO₂), manganese oxide (MnO₂), LiWO₂, LiMoO₂, In₂O₃, ZnO, SnO₂, NiO, TiO₂, V₂O₅, Nb₂O₅, or the like), a metal nitride (for example, LiN₃, BC₂N, or the like), a lithium composite oxide, or a carbon material such as graphite or coke.

When necessary, in the formation of the negative electrode active material layer 64 and the positive electrode active material layer 40, a conductive auxiliary agent and a binder that are similar to those used in the formation of the polarizable electrodes 10a and 10b of the electric double layer capacitor may be used.

Carbon Nanotubes

The carbon nanotubes 90a and 90b that are column-shaped conductors serving as auxiliary electrodes may be formed on surfaces of collectors (negative electrode collector layer 70 and positive electrode collector layer 30) in, for example, the following manner. To form the column-shaped conductors so as to have a desired sectional shape and be arranged in a desired pattern on the surfaces of the collectors, catalytic metal fine particles serving as cores for the growth of carbon nanotubes are formed in patterned regions of the surfaces of the collectors.

Specifically, for example, a metal serving as a catalyst is deposited onto the surfaces of the collectors by sputtering or the like through a mask formed so as to have openings that have shapes corresponding to the desired sectional shape and are arranged in the desired pattern. As a result, catalytic metal thin layers are formed on the patterned regions so as to have a desired thickness. Examples of the metal serving as a catalyst include Fe, Pd, Co, Ni, W, Mo, Mn, and alloys of the foregoing.

By heating the catalytic metal thin layers at a high temperature, catalytic metal fine particles (the size of the catalytic metal fine particles is determined by the thickness of the catalytic metal thin layers) are formed in the patterned regions. In the regions in which the catalytic metal fine particles are formed, the column-shaped conductors each of which is a structure constituted by a plurality of carbon nanotubes perpendicularly grown may be formed by a chemical vapor deposition (CVD) method or the like.

Collectors

The collectors (positive electrode collector layer 30 and negative electrode collector layer 70) may be formed of copper, stainless steel, nickel, or the like. The shape of the collectors is, for example, a foil, a plate, or a mesh (grid).

Electrolytic Layer

The electrolytic layer 50 may be formed of an inorganic electrolyte, a gel electrolyte, or a true polymer electrolyte.

The true polymer electrolyte may be prepared by, for example, making a polymer matrix of a polyalkylene ether polymer compound such as polyethylene oxide or polypropylene oxide hold a lithium salt such as lithium sulfonimide, LiClO₄, or LiO(SO₂CF₃).

The gel electrolyte may be prepared by, for example, making a polymer matrix hold a nonprotic solvent containing a lithium salt. For example, a gel electrolyte is prepared by making a polymer matrix of polyacrylonitrile (PAN) or the like hold a propylene carbonate-ethylene carbonate (PC-EC) solvent in which LiClO₄ has been dissolved.

Examples of a polymer that may be used for preparing such a gel electrolyte or a true polymer electrolyte include polyacrylonitrile (PAN), polyethylene glycol (PEG), polyvinylidene fluoride (PVdF), polyvinyl pyrrolidone, polytetraethylene glycol diacrylate, polyethylene oxide diacrylate, a copolymer between an acrylate including ethylene oxide and a polyfunctional acrylate, polyethylene oxide (PEO), polypropylene oxide (PPO), a vinylidene fluoride-hexafluoropropylene copolymer (PVdF-HEP), polymethyl methacrylate (PMMA), and polyvinyl chloride (PVC).

Examples of the inorganic electrolyte include Li₃PO₄N, (generally referred to as LiPON) prepared by adding nitrogen to Li₃PO₄ or Li₃PO₄; LiBO₂Nₓ, Li₄SiO₄—Li₃PO₄, and Li₄SiO₄—Li₃VO₄. The electrolytic layer 50 may be formed by subjecting the negative electrode collector layer 70 on which column-shaped conductors (for example, carbon nanotubes 90a) and the negative electrode active material layer 64 have been formed or the positive electrode collector layer 30 on which column-shaped conductors (for example, carbon nanotubes 90b) and the positive electrode active material layer 40 have been formed, to a thin-film formation process such as sputtering.

Whole Protective Layer

The whole protective layer 80, which has a low hygroscopicity and is resistant to moisture, protects the layers constituting the lithium-ion battery. The whole protective layer 80 may be formed of an ultraviolet curable acrylic resin, an ultraviolet curable epoxy resin, a parylene resin, or the like.

FIG. 9B is a partial enlarged view illustrating the directions 19 in which currents flow in the negative electrode active material layer 64 and the positive electrode active material layer 40. Specifically, FIG. 9B illustrates directions in which currents flow in the active material layers (negative electrode active material layer 64 and positive electrode active material layer 40) of the lithium-ion battery being discharged.

As illustrated in FIG. 9B, column-shaped conductors (carbon nanotubes 90a and 90b) serving as auxiliary electrodes are formed so as to satisfy the relationship h≦D≦2h or h≦d≦2h.

In FIG. 9B, currents flow from the active material layer (negative electrode active material layer 64) to the auxiliary electrodes (carbon nanotubes 90a) or to the collector (negative electrode collector layer 70).

Currents from two square regions having a side length of (d/2) in the active material layer (negative electrode active material layer 64) flow in the directions 19 that are perpendicular to the auxiliary electrodes (carbon nanotubes 90a) or the collector (negative electrode collector layer 70) toward the auxiliary electrodes (carbon nanotubes 90a) or the collector (negative electrode collector layer 70). Currents from a rectangular region having a long-side length of d and a short-side length of (h−(d/2)) in the active material layer (negative electrode active material layer 64) flow in the directions 19 that are perpendicular to the auxiliary electrodes (carbon nanotubes 90a) toward the auxiliary electrodes (carbon nanotubes 90a).

When the auxiliary electrodes (carbon nanotubes 90a) are not provided, currents from the region a distance h or less away from the collector (negative electrode collector layer 70) in the active material layer (negative electrode active material layer 64) flow in the directions 19 that are perpendicular to the collector (negative electrode collector layer 70) toward the collector (negative electrode collector layer 70).

In the example illustrated in FIGS. 9A and 9B, the auxiliary electrodes (carbon nanotubes 90a) are provided and the relationship D≦2h is satisfied and hence the relationship (d/2)<h is satisfied. Accordingly, currents from the active material layer (negative electrode active material layer 64) flow through the shortest current paths, which provides a low resistance, to the auxiliary electrodes (carbon nanotubes 90a) or the collector (negative electrode collector layer 70). Thus, loss due to the internal resistance can be suppressed.

Accordingly, in the example illustrated in FIGS. 9A and 9B, since currents from points that are a perpendicular distance h away from the collector (negative electrode collector layer 70) flow through current paths shorter than the distance h to the collector (negative electrode collector layer 70) and hence a high resistance is not caused.

In FIG. 9B, currents flow from the collector (positive electrode collector layer 30) or the auxiliary electrodes (carbon nanotubes 90b) to the active material layer (positive electrode active material layer 40). Currents from two square regions having a side length of (d/2) in the active material layer (positive electrode active material layer 40) flow in the directions 19 that are perpendicular to the auxiliary electrodes (carbon nanotubes 90b) or the collector (positive electrode collector layer 30). Currents from a rectangular region having a long-side length of d and a short-side length of (h−(d/2)) in the active material layer (positive electrode active material layer 40) flow in the directions 19 that are perpendicular to the carbon nanotubes 90b.

When the carbon nanotubes 90b are not provided, currents from the region that is a distance h or less away from the collector (positive electrode collector layer 30) in the active material layer (positive electrode active material layer 40) flow in the directions 19 that are perpendicular to the collector (positive electrode collector layer 30).

In the example illustrated in FIGS. 9A and 9B, the carbon nanotubes 90b are provided and the relationship D≦2h is satisfied and hence the relationship (d/2)<h is satisfied. Accordingly, currents from the active material layer (positive electrode active material layer 40) flow through the shortest current paths, which provides a low resistance, to the carbon nanotubes 90b or the collector (positive electrode collector layer 30). Thus, loss due to the internal resistance can be suppressed.

Accordingly, in the example illustrated in FIGS. 9A and 9B, since currents from points that are a perpendicular distance h away from the collector (positive electrode collector layer 30) flow through current paths shorter than the distance h to the collector (positive electrode collector layer 30) and hence a high resistance is not caused.

Examples of Arrangements of Column-Shaped Conductors and Wall-Shaped Conductors in Composite Electrodes

Other than the arrangements of column-shaped conductors and wall-shaped conductors in FIGS. 5A to 7B, for example, the following arrangements may be employed.

FIGS. 10A1 to 10D2 are plan views illustrating other arrangements of column-shaped conductors and wall-shaped conductors serving as auxiliary electrodes in composite electrodes according to an embodiment. Specifically, FIGS. 10A1 and 10A2 illustrate arrangements of column-shaped conductors; FIG. 10B illustrates an arrangement of wall-shaped conductor parts; FIG. 10C illustrates an arrangement of column-shaped conductor parts and column-shaped conductors; and FIGS. 10D1 and 10D2 illustrate honeycomb arrangements of honeycomb conductor parts.

Arrangements of Column-Shaped Conductors

FIGS. 10A1 and 10A2 illustrate arrangements of column-shaped conductors having a height h. For simplicity, the column-shaped conductors 120 are not illustrated but the central axes 120a thereof are illustrated. FIG. 10A1 illustrates a rectangular-grid arrangement and FIG. 10A2 illustrates a parallelogram-grid arrangement.

In the example illustrated in FIG. 10A1, the column-shaped conductors 120 are formed with the central axes 120a thereof being perpendicular to the surface of the plate-shaped conductor 110 such that the points at which the column-shaped conductors 120 and the plate-shaped conductor 110 are connected to each other constitute a rectangular-grid pattern, and the spacing between the central axes 120a of the column-shaped conductors 120 is D in the x direction and e in the y direction (where D>e and D satisfies h≦D≦2h).

In the example illustrated in FIG. 10A2, the column-shaped conductors 120 are formed with the central axes 120a thereof being perpendicular to the surface of the plate-shaped conductor 110 such that the points at which the column-shaped conductors 120 and the plate-shaped conductor 110 are connected to each other constitute a parallelogram-grid pattern, and the spacing between the central axes 120a of the column-shaped conductors 120 is D in the x direction and f in a direction intersecting the x direction (where D>f and D satisfies h≦D≦2h).

Arrangements of Wall-Shaped Conductor Parts

In the example illustrated in FIG. 10B, the wall-shaped conductors 130 in FIGS. 6A and 6B are replaced with an array of wall-shaped conductor parts 130a that have a thickness t and a length u and are arranged at a spacing d in the y direction, and the arrays are arranged at a spacing d in the x direction on a surface of the plate-shaped conductor 110. The wall-shaped conductor parts 130a are arranged such that D satisfies h≦D≦2h.

In the example illustrated in FIG. 10C, an arrangement in which the column-shaped conductors 120 and the wall-shaped conductor parts 130a are mixed is provided. In this example, the arrangement of the wall-shaped conductor parts 130a in FIG. 10B is changed such that the length of the wall-shaped conductor parts 130a is v and the column-shaped conductors 120 are arranged between the arrays of the wall-shaped conductor parts 130a arranged in the y direction. Each central axis of the column-shaped conductors 120 is disposed so as to be equidistant from end points of four neighboring wall-shaped conductor parts 130a. The column-shaped conductors 120 are arranged such that D satisfies h≦D≦2h.

In the examples of wall-shaped conductor arrangement in FIGS. 10B and 10C, the volume percentage of an active material formed between the auxiliary electrodes on the plate-shaped conductor (not shown) can be increased and the filling factor of the active material can be increased, compared with the example of wall-shaped conductor arrangement in FIGS. 6A and 6B.

Honeycomb Arrangements of Honeycomb Conductor Parts

FIGS. 10D1 and 10D2 illustrate examples of a honeycomb arrangement of honeycomb conductor parts (conductor parts that collectively constitute a honeycomb structure are referred to as “honeycomb conductor parts”). These arrangements are different from the honeycomb conductors that are illustrated in FIGS. 7A and 7B and have recesses having a square section and a regular hexagonal section parallel to the surface of the plate-shaped conductor, in that parts of walls constituting the recesses are not present. In the arrangements in FIGS. 10D1 and 10D2, structures similar to the honeycomb conductors in composite electrodes in FIGS. 7A and 7B are provided by arranging the honeycomb conductor parts 135a.

FIG. 10D1 illustrates a structure in which parts of the walls that constitute the recesses having a square section in FIG. 7A are removed by a length t. FIG. 10D2 illustrates a structure in which parts of the walls that constitute the recesses having a regular hexagonal section in FIG. 7B are removed by a length t. The length of the parts removed from the walls constituting the recesses may be larger than t. The honeycomb conductor parts 135a are arranged such that D satisfies h≦D≦2h.

In the examples of wall-shaped conductor arrangement in FIGS. 10D1 and 10D2, the volume percentage of an active material formed between the auxiliary electrodes on the plate-shaped conductor can be increased and the filling factor of the active material can be increased, compared with the examples of wall-shaped conductor arrangement in FIGS. 7A and 7B.

The column-shaped conductors 120 in FIGS. 10A1, 10A2, and 10C may be formed in a manner similar to that in which the column-shaped conductors 120 in FIGS. 4A and 5A are formed. The wall-shaped conductor parts 130a in FIGS. 10B and 10C and the honeycomb conductor parts 135a in FIGS. 10D1 and 10D2 may be formed in a manner similar to that in which the wall-shaped conductors 130 and the honeycomb conductors 135 in FIGS. 6A to 7B are formed.

Height of Column-Shaped/Wall-Shaped Conductors and Thickness of Active Material Layer in Composite Electrode

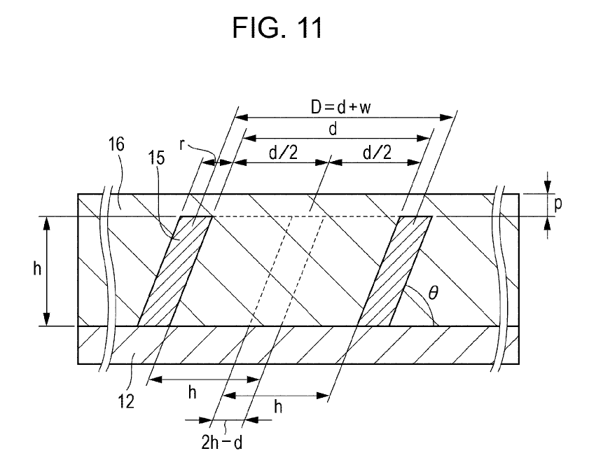

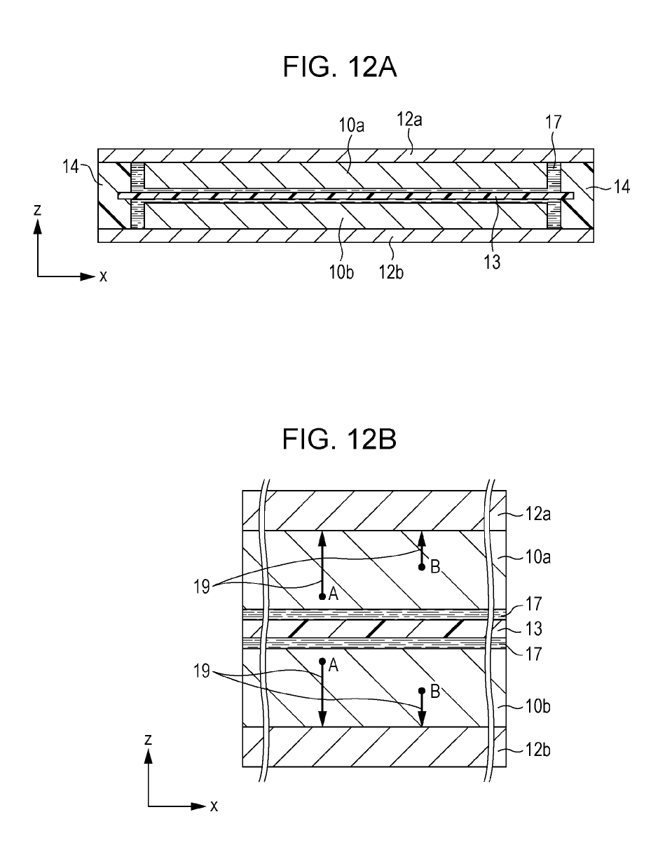

FIG. 11 is a sectional view illustrating the structure of a composite electrode including column-shaped conductors or wall-shaped conductors according to another embodiment.

When the height of the column-shaped/wall-shaped conductors 15 from the plate-shaped conductor 12 is defined as h and the thickness of the active material layer 16 is defined as w, the relationship between h and w may be w=h; however, as illustrated in FIG. 11, a relationship w−h=p>0 may be satisfied where p may be a desired value, for example, p=(2h−d). In FIG. 11, there may be cases where θ is 90° and the column-shaped/wall-shaped conductors 15 having a length L are perpendicular to the surface of the plate-shaped conductor 12. In these cases, h is equal to L.

The present application has been described so far with reference to embodiments. However, the present application is not restricted to these embodiments and various modifications can be made within the spirit and scope of the present application.

For example, when the composite electrode is used for an electric double layer capacitor and the auxiliary electrodes are formed of a metal, the collector and the auxiliary electrodes can be formed as a single member. Specifically, a metal plate having a thickness larger than h is etched through a mask with which metal columns or metal walls serving as auxiliary electrodes can be formed so as to have a desired sectional shape and be arranged in a desired pattern, such that the height of the auxiliary electrodes is made to be the desired value h. As a result, the auxiliary electrodes that have the desired sectional shape, are arranged in the desired pattern, and have the height h can be provided as a single member integrated with the collector.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. A composite electrode comprising:
a plate-shaped conductor;
a plurality of auxiliary electrodes disposed such that ends of the plurality of auxiliary electrodes are connected to a surface of the plate-shaped conductor and the plurality of auxiliary electrodes extend from the surface of the plate-shaped conductor; and
an active material layer formed between the plurality of auxiliary electrodes so as to be in contact with the plate-shaped conductor,
wherein, when a height of the plurality of auxiliary electrodes is defined as h, a center-to-center spacing of auxiliary electrodes facing each other in the plurality of auxiliary electrodes or a spacing of auxiliary electrodes facing each other in the plurality of auxiliary electrodes is h or more and 2h or less.

2. The composite electrode according to claim 1, wherein the plurality of auxiliary electrodes include column-shaped conductors.

3. The composite electrode according to claim 2, wherein the column-shaped conductors are arranged such that points at which the plate-shaped conductor and the column-shaped conductors are connected to each other constitute a square-grid pattern.

4. The composite electrode according to claim 3, wherein a center-to-center spacing of column-shaped conductors facing each other in the column-shaped conductors is (√2)h or more.

5. The composite electrode according to claim 2, wherein the column-shaped conductors are arranged such that points at which the plate-shaped conductor and the column-shaped conductors are connected to each other constitute a hexagonal-grid pattern.

6. The composite electrode according to claim 5, wherein a center-to-center spacing of column-shaped conductors facing each other in the column-shaped conductors is (√3)h or more.

7. The composite electrode according to claim 2, wherein the column-shaped conductors include conductive carbon nanotubes.

8. The composite electrode according to claim 2, wherein the column-shaped conductors include metal nanowires or metal nanotubes.

9. The composite electrode according to claim 1, wherein the plurality of auxiliary electrodes include wall-shaped conductors arranged in pairs so as to be parallel to each other.

10. The composite electrode according to claim 9,
wherein the wall-shaped conductors constitute a honeycomb structure including regions formed between the wall-shaped conductors arranged in pairs so as to be parallel to each other, and
the active material layer is formed in the regions.

11. The composite electrode according to claim 10, wherein the regions have a square shape.

12. The composite electrode according to claim 10, wherein the regions have a regular hexagonal shape.

13. The composite electrode according to claim 9, wherein the wall-shaped conductors include conductive carbon nanowalls.

14. The composite electrode according to claim 9, wherein the wall-shaped conductors are composed of a metal.

15. An electronic device comprising the composite electrode according to claim 1.

16. The electronic device according to claim 15,
wherein two of the composite electrodes are disposed so as to face each other with a separator therebetween,
at least one of the composite electrodes is formed as a polarizable electrode, and
the electronic device serves as an electric double layer capacitor.

17. The electronic device according to claim 15, comprising:
a positive electrode including a positive electrode collector and a positive electrode active material layer;
a negative electrode including a negative electrode collector and a negative electrode active material layer; and
an electrolytic layer disposed between the positive electrode and the negative electrode,
wherein at least one of the positive electrode and the negative electrode includes the composite electrode, and
the electronic device serves as a secondary battery.

18. The electronic device according to claim 17, wherein the secondary battery is a lithium-ion secondary battery.
